(19) United States
(12) Patent Application Publication
(10) Pub. No.: US 2015/0302008 A1
(43) Pub. Date: Oct. 22, 2015

(54) CONTROL APPARATUS, MANAGEMENT SYSTEM, AND CONTROL METHOD

(71) Applicant: Hitachi, Ltd, Tokyo (JP)

(72) Inventors: Daisuke ISHII, Tokyo (JP); Masashi YANO, Tokyo (JP); Michitaka OKUNO, Tokyo (JP); Nodoka MIMURA, Tokyo (JP); Yuta MUTO, Tokyo (JP)

(73) Assignee: HITACHI, LTD., Tokyo (JP)

(21) Appl. No.: 14/689,960

(22) Filed: Apr. 17, 2015

(30) Foreign Application Priority Data
Apr. 21, 2014 (JP) 2014-087290

(51) Int. Cl. G06F 17/30

(52) U.S. Cl. CPC G06F 17/303; G06F 17/30575

(57) ABSTRACT

It is provided a control apparatus being configured to: calculate a number of groups to which plurality of data processing apparatus are to belong; determine an associated group of each of the plurality of data processing apparatus; determine an operational data item to be assigned to the associated group; determine as an assignment destination of the operational data item assigned to the associated group, any one of the data processing apparatus belonging to the associated group whose number is the minimum count or larger, and determine as an assignment destination of a redundant data item, the data processing apparatus that is different front the data processing apparatus corresponding to an assignment destination of the operational data item; and assign based on determination results, the group of operational data items and a group of the redundant data items to the plurality of data processing apparatus.

### CLAIM OF PRIORITY

The present application claims priority from Japanese patent application JP 2014-87290 filed on Apr. 21, 2014, the content of which is hereby incorporated by reference into this application.

### BACKGROUND OF THE INVENTION

This invention relates to a control apparatus, management system and control method for controlling a control target.

Hitherto, there is disclosed a distributed processing system for distributing processing to a plurality of servers and reconfiguring processing assigned to each of the servers in response to the increase in load or the addition or removal of servers (JP 2012-238084 A). In a data load distribution arrangement system disclosed in JP 2012-238084 A, a server arrangement apparatus calculates, for each DB server, an absolute value of a difference between a load, and a server threshold, and generates a set of servers S− whose load is equal to or smaller than the server threshold and a set of servers S+ whose load exceeds the server threshold. Then, in order from the DB server having the largest absolute value among the servers S+, the server arrangement apparatus arranges one of the servers S− to an area corresponding to an excessed portion of an area assigned to the DB server in a hash space, to thereby create server-assigned data information. Each of the DB servers exchanges, based on the server-assigned data information created by the server arrangement apparatus, data held by itself with data in another DB server.

In JP 2012-238084 A, data assignment processing for load distribution is executed among the plurality of DB servers. When the DB server is added, in order to alleviate the loads, the added DB server needs to take over a part of processing from all member servers constructing a cluster, and to migrate the data to be taken over from another DB server. On the other hand, when the DB server is removed, the remaining DB servers need to assume the processing of the removed DB server to compensate for the lost processing. Further, in order to reconstruct a redundant system with the remaining DB servers, it is necessary to place redundant data, which is a replica of operational data, in another DB server. This necessitates the migration of data among the DB servers.

All the DB servers constructing the cluster are involved in the data migration at the time of addition and removal of the DB server. In some cases, the data is not migrated normally due to a failure. As a specific example of the failure occurring during the data migration, the data migration is interrupted due to the disconnection or defect of a network cable connecting the DB servers to one another. As another example, due to a defect in a program, processing of taking over data received by the added DB server cannot be executed normally, and hence the added DB server does not start service processing normally. Accordingly, when a failure occurs during the data migration, the influence of the failure spreads to affect all the DB servers, and in the worst case, all the DB servers are shut down.

### SUMMARY OF THE INVENTION

It is an object of this invention to suppress the affected range of a failure at the time of data migration.

An aspect of the invention disclosed in this application is a control apparatus configured to control a plurality of data processing apparatus capable of processing a group of operational data items, the group of operational data items being a group of data items currently used for operation, the control apparatus comprising: a processor configured to execute a program; and a memory configured to store the program, the processor being configured to execute: calculation processing of calculating, based on a number of the plurality of data processing apparatus and a minimum count, which is a minimum number of data processing apparatus required to be included in one group, a number of groups to which the plurality of data processing apparatus are to belong; first determination processing of determining, from among at least one group, which is specified based on the number of groups calculated by the calculation processing, an associated group of each of the plurality of data processing apparatus, the associated group being a group to which the each of the plurality of data processing apparatus is to belong; second determination processing of determining, from among the group of operational data items, the operational data item to be assigned to the associated group determined by the first determination processing; third determination processing of determining, as an assignment destination of the operational data item assigned to the associated group by the second determination processing, any one of the data processing apparatus belonging to the associated group whose number is the minimum count or larger, and of determining, as an assignment destination of a redundant data item that is a replica of the operational data item assigned to the associated group, from among the data processing apparatus belonging to the associated group whose number is the minimum count or larger, the data processing apparatus that is different from the data processing apparatus corresponding to an assignment destination of the operational data item that is an original of the redundant data item; and assignment processing of assigning, based on determination results obtained by the second determination processing and the third determination processing, the group of operational data items and a group of the redundant data items to the plurality of data processing apparatus.

According to the representative embodiment of this invention, it is possible to suppress the affected range of a failure at the time of data migration. Other objects, configurations, and effects than those described above are clarified by the following description of an embodiment.

### BRIEF DESCRIPTION OF THE DRAWINGS

FIG. 1 is an explanatory diagram illustrating an example of server addition according to a first embodiment of this invention.

FIG. 2 is an explanatory diagram illustrating an example of server removal according to the first embodiment.

FIG. 3 is a block diagram illustrating a system configuration example of the management system according to the first embodiment.

FIG. 4 is an explanatory diagram illustrating processing of determining the session group number p and processing of assigning the packet, which are performed by each load distribution apparatus.

FIG. 5 is a block diagram illustrating a hardware configuration example of each of the control apparatus, the load distribution apparatus, and the server.

FIG. 6 is an explanatory diagram showing an example of redundancy group information.

FIG. 7 is an explanatory diagram showing an example of session group information.

FIG. 8 is a flowchart illustrating a processing procedure example for an initial configuration of the redundancy group, which is performed by the control apparatus.

FIG. 9 is an explanatory diagram illustrating an example of a change of the redundancy group at the time of the server addition.

FIG. 10 is an explanatory diagram illustrating the redundancy groups before the server addition.

FIG. 11 is an explanatory diagram showing an update example of the redundancy group information.

FIG. 12 is an explanatory diagram showing an update example of the session group information.

FIG. 13 is an explanatory diagram illustrating State Information Rearrangement Operation Example 1 at the time of server addition.

FIG. 14 is an explanation diagram illustrating State Information Rearrangement Operation Result 1 at the time of server addition.

FIG. 15 is an explanatory diagram showing an update example of the association information.

FIG. 16 is an explanatory diagram illustrating State information Rearrangement Operation Example 2 at the time of server addition.

FIG. 17 is an explanatory diagram illustrating State information Rearrangement Operation Result 2 at the time of server addition.

FIG. 18 is a flowchart illustrating Redundancy Group Update Processing Example 1 performed by the control apparatus.

FIG. 19 is an explanatory diagram illustrating an example of a change of the redundancy group at the time of the server removal.

FIG. 20 is an explanatory diagram illustrating the redundancy groups before the server removal.

FIG. 21 is an explanatory diagram showing an update example of the redundancy group information.

FIG. 22 is an explanatory diagram showing an update example of the session group information.

FIG. 23 is an explanatory diagram illustrating State Information Rearrangement Operation Example 1 at the time of server removal.

FIG. 24 is an explanatory diagram showing an update example of the association information.

FIG. 25 is an explanatory diagram illustrating State Information Rearrangement Operation Example 2 at the time of server removal.

FIG. 26 is an explanatory diagram illustrating a state information rearrangement operation result at the time of server removal of FIG. 25.

FIG. 27 is a flowchart illustrating Redundancy Group Update Processing Example 2 performed by the control apparatus.

FIG. 28 is an explanatory diagram illustrating redundancy groups according to the second embodiment.

FIG. 29 is an explanatory diagram illustrating a state information rearrangement example caused by the addition or removal of the server according to the second embodiment.

FIG. 30 is a block diagram illustrating a hardware configuration example of a management system according to the third embodiment.

### DETAILED DESCRIPTION OF THE PREFERRED EMBODIMENTS

Now, referring to the attached drawings, a description is given of a management system according to embodiments of this invention. In the following embodiments, a description is given taking a gateway system as an example of the management system. It should be noted that “operational data” as used herein refers to data currently used for operation. Further, “redundant data” as used herein refers to replicated data of the operational data such as backup data of the operational data.

### First Embodiment

(Example of Server Addition)

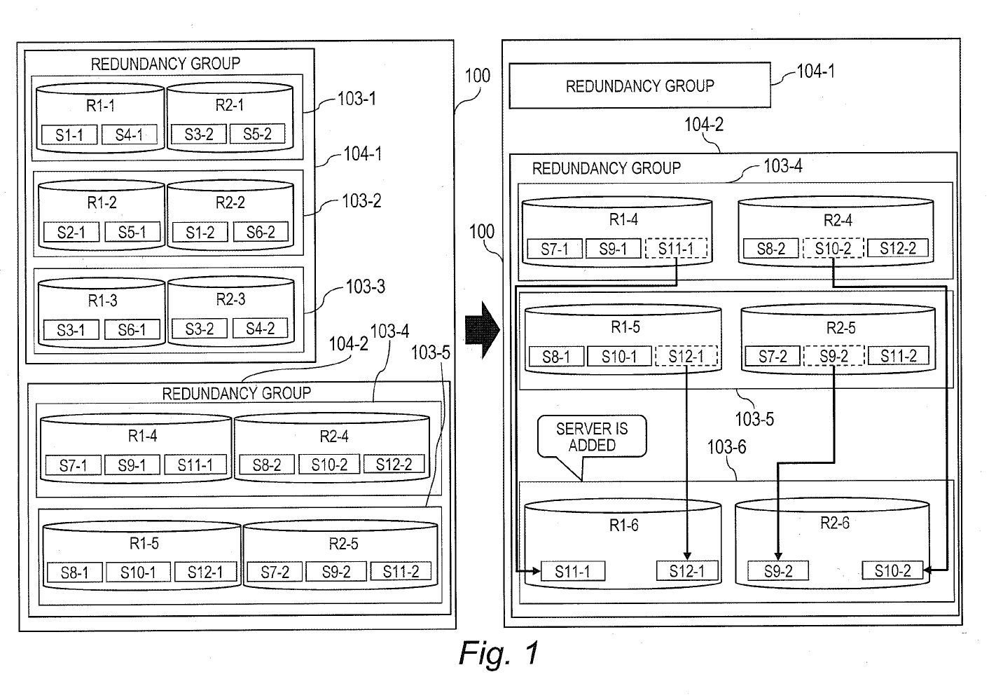

FIG. 1 is an explanatory diagram illustrating an example of server addition according to a first embodiment of this invention. The left part of FIG. 1 illustrates a state before the server addition, and the right part of FIG. 1 illustrates a state after the server addition. A management system 100 includes a plurality of redundancy groups, and in FIG. 1, the management system 100 includes two redundancy groups 104-1 and 104-2. The “redundancy group” refers to a set of servers as an example of data processing apparatus constructing a redundant system. It should be noted that the redundancy groups are each denoted by reference symbol 104-g. The symbol “g” represents a number specifying a specific one of the redundancy groups 104-g, g is an integer satisfying 1≦g≦G. The symbol “G” represents a total number of the redundancy groups 104-g, and is an integer satisfying G≧1.

Further, the management system 100 includes a plurality of servers serving as a plurality of data processing apparatus. In the example of FIG. 1, in the management system 100, the redundancy group 104-1 includes three servers 103-1 to 103-3, and the redundancy group 104-2 includes two servers 103-4 and 103-5. It should be noted that the servers are each denoted by reference symbol 103-j. The symbol “j” represents a number (server number) specifying a specific one of the servers 103-j, and is an integer satisfying 1≦j≦N. The symbol “N” represents a total number of the servers 103-j, and is an integer satisfying N≧1. It should be noted that each of the servers 103-j may be any one of a physical machine and a virtual machine.

Each of the servers 103-j includes an operational data set R1-j and a redundant data set R2-j. The operational data set R1-j is a set of at least one operational data item. The redundant data set R2-j is a set of at least one redundant data item. The symbol “R1” indicates the operation, and the symbol “R2” indicates the redundancy. The operational data and the redundant data are, for example, state information on a group of sessions among apparatus holding communication to one another via the management system 100. The “state information” refers to information indicating a communication state for each of the sessions. Examples of the state information include information indicating a state in which connection is being requested from one apparatus (e.g., a user terminal) to another apparatus (e.g., a Web server) and information indicating a state in which a session is established between those apparatus, as well as a transfer amount (packet count) from one apparatus to another apparatus.

In this example, each state information item on the session group p as the operational data is denoted by reference symbol Sp-1, and each state information item on the session group p as the redundant data is denoted by reference symbol Sp-2. In other words, a branch number “1” indicates the operational data, and a branch number “2” indicates the redundant data. The “p” represents a number (session group number) specifying a specific one of the session groups, which is, for example, characteristic information acquired from a packet (e.g., a hash value of a transmission source address or a destination address). In other words, a set of sessions having the same hash value is the session group.

Each of the servers 103-j stores the redundant data of the operational data held by another server 103-k (j≠k) included in the same redundancy group 104-g as the redundancy group 104-g to which this server 103-j belongs, to thereby construct a redundant system. Taking the server 103-1 as an example, state information items S1-1 and S4-1 are stored in an operational data set R1-1, and state information items S3-2 and S5-2 are stored in a redundant data set R2-1. Operational data items as originals of the state information items S3-2, and S5-2 are state information items S3-1 and S5-1. The state information items S3-1 and S5-1 are not stored in the server 103-1 or the redundancy group 104-2, but stored in other servers 103-3 and 103-2, respectively.

Further, when a server 103-(N+1) is added in any one of the redundancy groups 104-g, rearrangement of the configuration is executed within the redundancy group 104-g to which the server 103-(N+1) is added. The rearrangement of the configuration refers to processing of rearranging assign destinations of a group of operational data items and a group of redundant data items that are stored in all the servers 103-j included in the redundancy group 104-g including the added server 103-(N+1).

For example, as described above, the servers 103-j included in the redundancy group 104-g after the addition of the server 103-(N+1) store different operational data items in their respective operational data sets R1-j. Further, each of the servers 103-j stores the redundant data of the operational data held by another server 103-k (j≠k) included in the same redundancy group 104-g as the redundancy group 104-g to which this server 103-j belongs. In this way, the redundant system is constructed in each of the servers 103-j. In this case, the group of operational data items and the group of redundant data items before the addition are rearranged so that the number of operational data items and the number of redundant data items become equal among the servers 103-j including the added server 103-(N+1).

For example, in the right part of FIG. 1, the addition of a server 103-6 to the redundancy group 104-2 causes the configuration rearrangement to be executed within the redundancy group 104-2. In FIG. 1, each of the thick arrows indicates migration of the operational data or the redundant data. The broken-line rectangle on the start side of each thick arrow is the operational data or the redundant data in a migration source, and after the migration, this rectangle is removed from the operational data set R1-j or the redundant data set R2-j as the migration source, The rectangle on the end side of each thick arrow is the operational data or the redundant data that has been migrated from the operational data set R1-j or the redundant data set R2-j as the migration source.

In this example, the servers 103-4 and 103-5 each store three operational data items and three redundant data items before the addition of the server 103-6, but after the addition of the server 103-6, the servers 103-4 to 103-6 each store two operational data items and two redundant data items. It should be noted that in some cases, the operational data items and the redundant data items are not equally assigned to each of the servers depending on the number of operational data items and the number of redundant data items. In this case, it suffices if, for example, the operational data items and the redundant data items are rearranged so that a difference in the number of operational data its among the servers 103-j and a difference in the number of redundant data items among the servers 103-j are minimized.

As described above, the affected range of a failure that may occur during the rearrangement of the operational data and the redundant data at the time of the server addition can be suppressed within the redundancy group 104-2, and hence the failure does riot spread to affect the redundancy group 104-1.

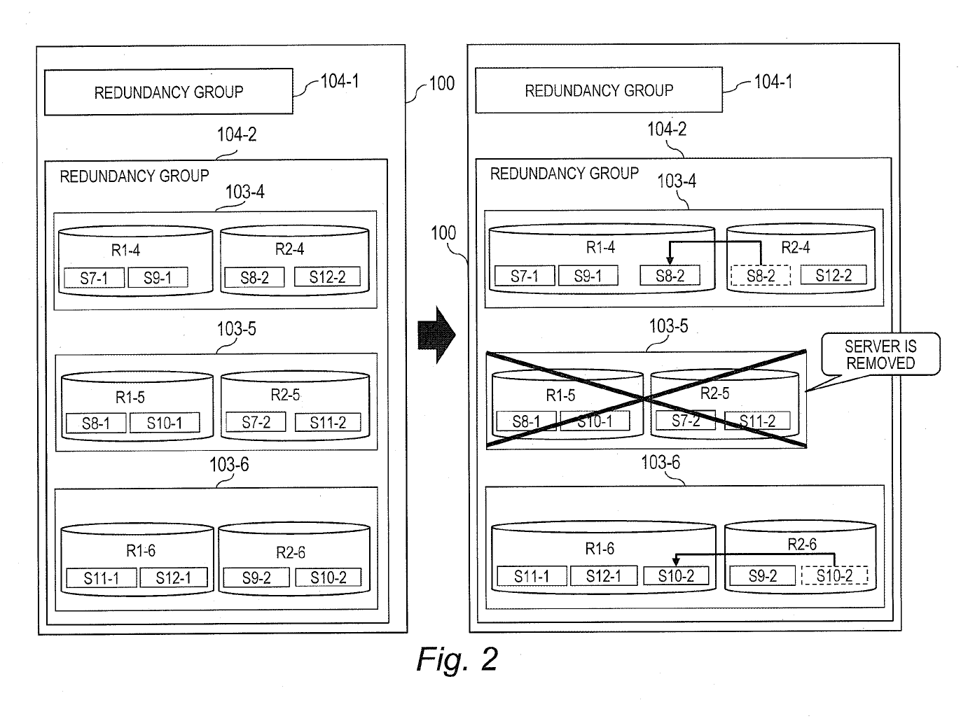

FIG. 2 is an explanatory diagram illustrating an example of server removal according to the first embodiment. The left part of FIG. 2 illustrates a state before the server removal, and the right part of FIG. 2 illustrates a state after the server removal. It is assumed here that the left part of FIG. 2 is the same as the right part of FIG. 1 in their configurations, and a description is given taking as an example a case where the server 103-5 of the redundancy group 104-2 is removed by an administrator's operation or due to a failure of the server 103-5.

When the server 103-5 is removed, state information items S8-1 and S10-1 included in an operational data set R1-5 are also removed from the redundancy group 104-2. Accordingly, in the management system 100, other servers than the removed server 103-5, namely, the servers 103-4 and 103-6, rearrange state information items S8-2 and S10-2 as the redundant data of the state information items S8-1 and S10-1 to change the redundant data into the operational data.

Specifically, for example, as illustrated in the right part of FIG. 2, the server 103-4 changes an assigned attribute of the state information item S8-2 of the redundant data set R2-4 from the redundant data set R2-4 to the operational data set R1-4. In a similar manner, the server 103-6 changes an assigned attribute of the state information item S10-2 of the redundant data set R2-6 from the redundant data set R2-6 to the operational data set R1-6. The redundant data whose assigned attribute has been changed becomes the operational data, and hence the branch number of its reference symbol becomes “1”. In this change, the data is not migrated, and only an identifier indicating the assigned attribute is changed. It is therefore possible to achieve an increase in speed of the rearrangement for changing the redundant data into the operational data.

In this manner, when the server 103-k included in a given redundancy group 104-g is removed, the server 103-j included in the same redundancy group 104-g takes over the processing of the removed server 103-k by using the redundant data (state information item Sp-2) of the removed server 103-k included in the redundant data set R2-j as the operational data. The management system 100 thus continues service processing. As described above, the configuration rearrangement in the given redundancy group 104-g does not spread to affect another redundancy group, and hence it is possible to achieve enhancement of security in data management.

<System Configuration Example>

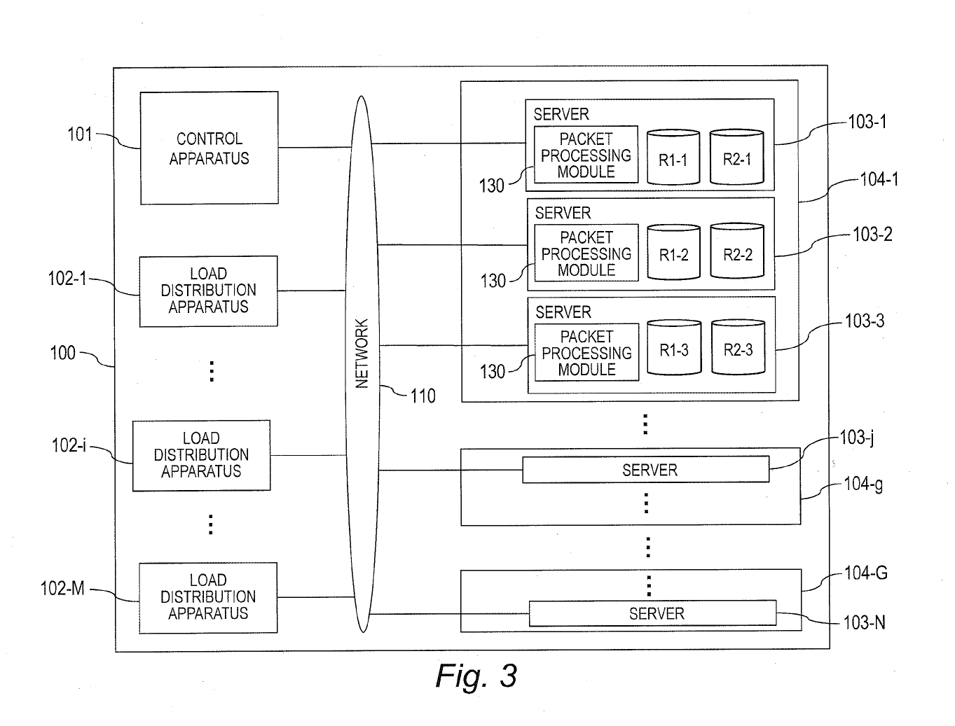

FIG. 3 is a block diagram illustrating a system configuration example of the management system 100 according to the first embodiment. The management system 100 includes a control apparatus 101, load distribution apparatus 102-i (the symbol “i” represents an integer satisfying 1≦i≦M, where the symbol “M” represents a total number of load distribution apparatus), and the redundancy groups 104-g. The control apparatus 101, the load distribution apparatus 102-i, and the plurality of redundancy groups 104-g are coupled to one another via a network 110 such as a local area network (LAN), a wide area network (WAN), or the Internet. The control apparatus 101 manages the entire management system 100, and executes assigned session group changing processing, failure recovery processing, and redundant system reconstruction processing.

The assigned session group changing processing is processing of migrating, when the server 103-(N+1) is added, a part of the state information items Sp-1 as the operational data from the existing servers 103-1 to 103-N to the added server 103-(N+1), and controlling the added server 103-(N+1) to take over the data processing. With this processing, it is possible to achieve load distribution among the servers 103-j including the added server 103-(N+1).

The failure recovery processing is processing of controlling, when a given server 103-j among the plurality of servers 103-1 to 103-N fails, the server 103-k (k≠j) to take over the data processing of the failed server 103-j. With this processing, the management system 100 can continue the service processing.

The redundant system reconstruction processing is processing of, in response to the addition or removal of the server 103-j, rearranging the configuration of the state information item Sp-2 as the redundant data to reconstruct the redundant system. For example, when the server 103-(N+1) is added, through the redundant system reconstruction processing, the management system 100 migrates a part of the redundant data of the servers 103-1 to 103-N to the added server 103-(N+1). With this, all the servers 103-1 to 103-N and 103-(N+1) including the added server 103-(N+1) construct the redundant system so as to be ready to address the next failure.

When the server 103-j is removed, after performing the failure recovery processing in response to the removal of the server 103-j, through the redundant system reconstruction processing, the management system 100 generates on the remaining server 103-k (k≠j) the redundant data that has been lost by the failure recovery processing. With this, the remaining servers 103-k can be prepared for the next occurrence of a failure.

Each of the load distribution apparatus 102-i transmits and receives a packet. Each load distribution apparatus 102-i determines the session group of the input packet based on the characteristic information specifying the session of the input packet. In the case where the management system 100 is the gateway system, the destination address of the packet is used as the characteristic information, for example. It should be noted that information to be adopted as the characteristic information is not limited to the destination address, and it suffices if information suited to a system, protocol, and service to be applied is adopted.

Further, each load distribution apparatus 102-i determines the session group of the input packet, and transfers the packet to one of the servers 103-j in charge of the determined session group of the packet. How to determine the session group and how to assign the packet are described later. Further, each load distribution apparatus 102-i transfers the packet that has been processed by a packet processing module 130 of each server 103-j to the outside. Each of the load distribution apparatus 102-i realizes the same function.

Each server 103-j manages the state information items Sp-1 and Sp-2 on the session of the packet, which is transferred from the load distribution apparatus 102-i. Each server 103-j includes the packet processing module 130, the operational data set R1-j, and the redundant data set R2-j. The packet processing module 130 analyzes the packet to acquire the characteristic information specifying the session, such as the destination address or transmission source address of the packet, and saves the state information item Sp-1 that is a result of the packet processing to the operational data set R1-j as the operational data.

Further, when a given operational data item of a given server 103-j is updated, the redundant data item corresponding to the given operational data item is also updated. For example, in FIG. 1, when the state information item S1-1 on a session group 1 stored in the operational data set R1-1 of the server 103-1 is updated, the state information item S1-2 stored in a redundant data set R2-2 of the server 103-2 as the redundant data of the state information item S1-1 is also updated. In other words, the state information item S1-2 stored in the redundant data set R2-2 of the server 103-2 is overwritten with the updated state information item S1-1 on the session group 1. As described above, the update processing for the redundant data is executed by replicating, by the server 103-j storing the updated operational data, the state information item Sp-1 as the updated operational data to the server 103-k (j≠k) storing the redundant data of the updated state information item Sp-1.

The redundancy groups 104-g are each a group to which at least one server 103-j constructing the redundant system is assigned. For example, in the examples of FIG. 1 and FIG. 3, the servers 103-1 to 103-3 belong to the same redundancy group 104-1. The redundant data (state information item Sp-2), which is the replica of the operational data (state information item Sp-1) stored in the operational data set R1-1 of the server 103-1, is stored in any one of the redundant data sets R2-2 and R2-3 of the other servers 103-2 and 103-3 belonging to the redundancy group 104-1.

It should be noted that the redundant data (state information item Sp-2), which is the replica of the operational data (state information item Sp-1) of each server 103-j, is never stored in the redundant data set R2-j of the same server 103-j. Further, the operational data and the redundant data stored in one of the redundancy groups 104-g are never stored in another redundancy group 104-h (g≠h), except for division of the redundancy group 104-g and merging of the redundancy groups 104-g, which are described later.

Now, a description is given of an example of packet transfer to the outside, which is performed by the management system 100. The packet transferred from each server 103-j is input to the network 110. The network 110 selects, based on the destination address of the transferred packet, one of the load distribution apparatus 102-i capable of transferring this packet to a network (not shown in figures) close to the destination address, and transfers the transferred packet to the selected load distribution apparatus 102-i. This load distribution apparatus 102-i transfers the transferred packet to the outside of the management system 100.

<Processing Example Performed by Each Load Distribution Apparatus 102-i>

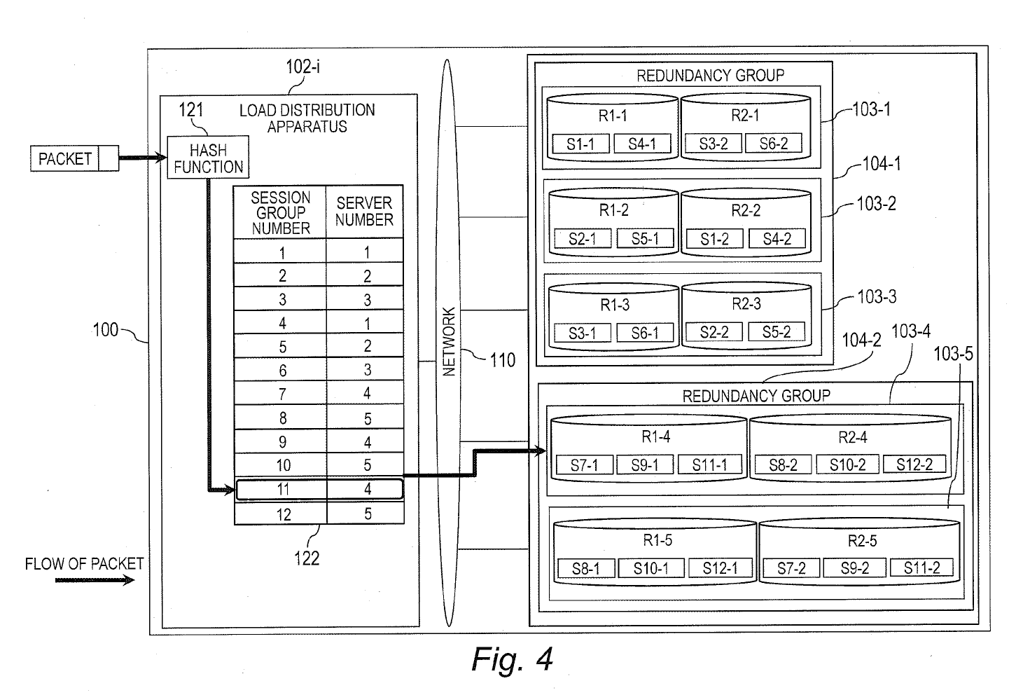

FIG. 4 is an explanatory diagram illustrating processing of determining the session group number p and processing of assigning the packet, which are performed by each load distribution apparatus 102-i. The load distribution apparatus 102-i includes a hash function 121 and association information 122. The load distribution apparatus 102-i uses the hash function 121 to extract, from the input packet, the characteristic information specifying the session. Specifically, for example, the load distribution apparatus 102-i gives, to the hash function 121, the destination address of the packet as the characteristic information specifying the session, and extracts the hash value.

The association information 122 is a table associating the session group number p with the server number j. The session group number p is information specifying the session group of the input packet. Further, the server number j is information specifying each server 103-j. In this embodiment, based on the characteristic information specifying the session of the input packet, such as the destination address thereof, the management system 100 classifies the input packets into the session groups, which are each a unit to be used for distribution of the packets to the servers 103-j.

In other words, the session group is a unit obtained by aggregating a plurality of packet communication sessions. More specifically, the session group is a set of sessions having the same hash value that has been obtained from the characteristic information specifying the session of the input packet. In other words, the session group number p of the association information 122 is a value that can be assumed by the hash value. In FIG. 4, for convenience of description, the number of session groups is “12”, and the number of servers 103-j are “5”. For example, when a packet is input to the load distribution apparatus 102-i, a session group number “11” as the hash value is extracted from the packet through use of the hash function 121. In the association information 122, the server number j associated with the session group number “11” is “4”. The load distribution apparatus 102-i therefore determines the server 103-4 as the transfer destination of the packet, and transfers the packet to the server 103-4.

The server 103-4 controls the packet processing module 130 to process the packet transferred thereto, and extracts session information. The extracted session information is the state information on the session corresponding to the session group “11”. The server 103-4 then adds the extracted session information to a state information item S11-1 of the session group “11”.

<Hardware Configuration Example>

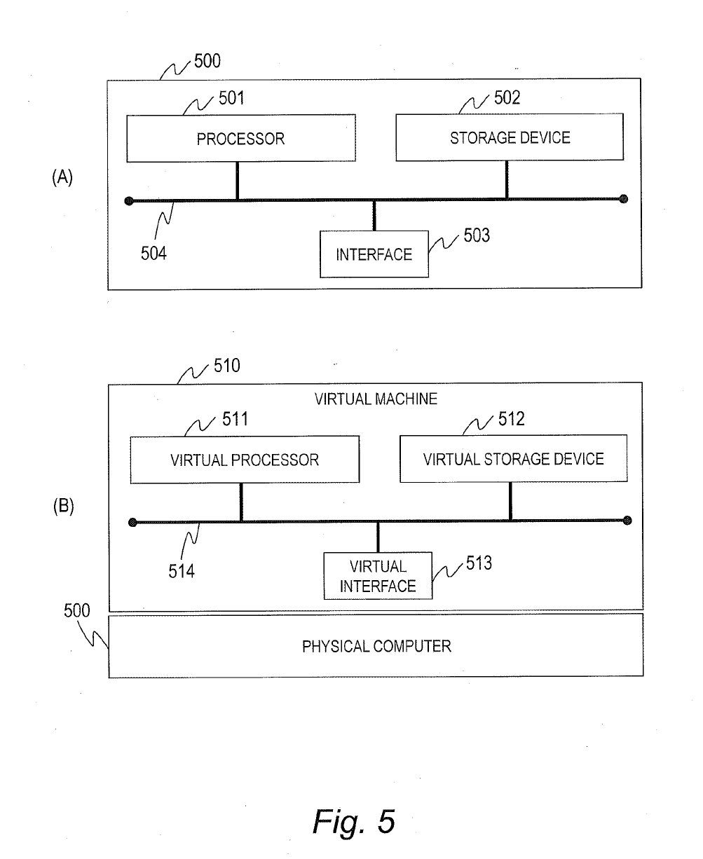

FIG. 5 is a block diagram illustrating a hardware configuration example of each of the control apparatus 101, the load distribution apparatus 102-i, and the server 103-j. Part (A) of FIG. 5 illustrates a hardware configuration example of a physical computer 500, and part (B) of FIG. 5 illustrates a hardware configuration example of a virtual machine 510 created on the physical computer 500. Any one of the configurations of parts (A) and (B) of FIG. 5 can be adopted as the configuration of each of the control apparatus 101, the load distribution apparatus 102-i, and the server 103-j.

In the configuration of part (A) of FIG. 5, the physical computer 500 serving as the control apparatus 101, the load distribution apparatus 102-i, or the server 103-j includes a processor 501, a storage device 502, an interface 503, and a bus 504. The processor 501, the storage device 502, and the interface 503 are coupled to one another via the bus 504. The processor 501 reads a program stored in the storage device 502 to execute processing based on the program. The storage device 502 stores the program for implementing the processing to be performed by the control apparatus 101, the load distribution apparatus 102-i, or the server 103-j. The storage device 502 also stores data and a table to be referred to when the program is executed. The interface 503 allows the input and output of data.

In the configuration of part (B) of FIG. 5, the virtual machine 510 serving as the control apparatus 101, the load distribution apparatus 102-i, or the server 103-j includes a virtual processor 511, a virtual storage device 512, a virtual interface 513, and a virtual bus 514. A plurality of virtual machines 510 may be created on the physical computer 500. The virtual processor 511, the virtual storage device 512, and the virtual interface 513 are coupled to one another via the virtual bus 514. The virtual processor 511 reads a program stored in the virtual storage device 512 to execute processing based on the program. The virtual storage device 512 stores the program for implementing the processing to be performed by the control apparatus 101, the load distribution apparatus 102-i, or the server 103-j. The virtual storage device 512 also stores data and a table to be referred to when the program is executed. The virtual interface 513 allows the input and output of data.

<Redundancy Group Information>

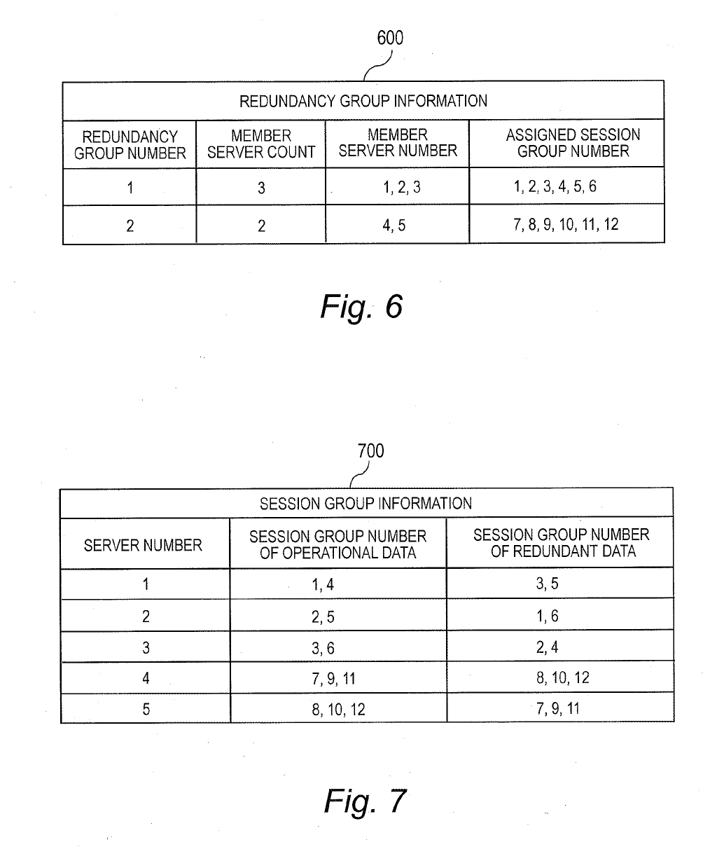

FIG. 6 is an explanatory diagram showing an example of redundancy group information. Redundancy group information 600 is stored in the control apparatus 101. The redundancy group information 600 is information showing the number of servers 103-j held by each redundancy group 104-g, a specific server 103-j held by each redundancy group 104-g, and a specific session group assigned to this specific server 103-j.

The redundancy group information 600 associates columns of a redundancy group number, a member server count, a member server number, and an assigned session group number with one another, and includes values of the respective columns for each redundancy group. In the column of the redundancy group number, the redundancy group number g is stored. In the column of the member server count, the number of servers belonging to the redundancy group 104-g specified by the redundancy group number g is stored. In the column of the member server number, the server number j specifying each of the servers belonging to the redundancy group 104-g specified by the redundancy group number g is stored. In the column of the assigned session group number, all the session group numbers p assigned to the servers 103-j belonging to the redundancy group 104-g specified by the redundancy group number g are stored.

For example, an entry of the first row shows that the redundancy group 104-1 holds three servers 103-i, that the three servers 103-j are the servers 103-1 to 103-3, and that the servers 103-1 to 103-3 hold the state information items S1-1 to S6-1 and S1-2 to S6-2.

<Session Group Information>

FIG. 7 is an explanatory diagram showing an example of session group information. Session group information 700 is stored in the control apparatus 101. The session group information 700 is information showing a specific operational data item and a specific redundant data item that are held by each server 103-j. The session group information 700 associates columns of a server number, a session group number of operational data and a session group number of redundant data with one another, and includes values of the respective columns for each server 103-j.

In the column of the server number, the server number j is stored. In the column of the session group number of operational data, the session group number p relating to the state information item Sp-1, which is the operational data held by the server 103-j specified by the server number j, is stored. In the column of the session group number of redundant data, the session group number p relating to the state information item Sp-2, which is the redundant data held by the server 103-j specified by the server number j, is stored.

For example, an entry of the first row shows that the server 103-1 holds the state information items S1-1 and S4-1 as the operational data and the state information items S3-2 and S5-2 as the redundant data.

<Processing Procedure for Initial Configuration of Redundancy Group>

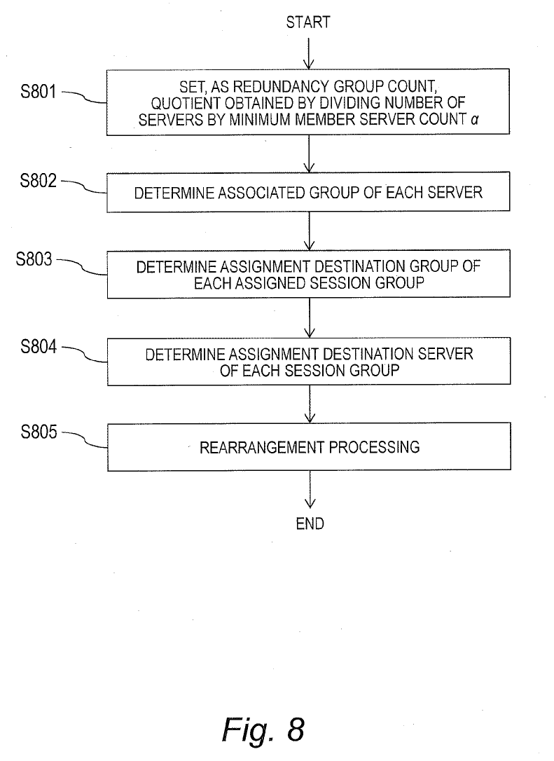

FIG. 8 is a flowchart illustrating a processing procedure example for an initial configuration of the redundancy group, which is performed by the control apparatus 101. At the beginning, the control apparatus 101 determines the configuration of the redundancy group 104-g. First, the administrator of the management system 100 controls the control apparatus 101 to set a minimum member server count α (the symbol “α” represents an integer satisfying α≧2), which is the minimum value of the member server count of each redundancy group 104-g. The control apparatus 101 calculates a quotient obtained by dividing the number N of the servers 103-1 to 103-N included in the management system by the minimum member server count α, and sets the calculated quotient as the redundancy group count G (Step S801), In the example of FIGS. 1, N=5 and α=2, and hence the redundancy group count G is calculated to be “2”, which is a quotient obtained by N/α.

It should be noted that the minimum member server count α is determined in consideration, for example, of the maximum number N of the servers 103-j to be used in the management system 100 and of time of data transfer among the servers 103-j. For example, in the management system 100 that uses 100 servers 103-j at the minimum, when the affected range of a failure that may occur at the time of state information rearrangement is desired to be suppressed to 10 percent of the total number of servers, the maximum number N of the servers 103-j to be subjected to the state information, rearrangement is N=(3α−2), and hence it suffices if (3α−2) is “10”, which corresponds to 10 percent of “100” as the maximum number N of the servers 103-j. In other words, it suffices if the value of the minimum member server count α is set to “4” based on the relationship of “3α−2=10”. A reason why the maximum number N of the servers 103-j to be subjected to the state information rearrangement is N=(3α−2) is described later.

Further, a description is given of an example of the management system 100 in which at the time of state information rearrangement, each server 103-j migrates a 1-gigabit state information item Sp-1 or Sp-2 at a network speed of 1 gigabit per second. When state info-nation rearrangement time required of the addition or removal of one server 103-j needs to be suppressed to 10 seconds or shorter, a case is assumed where it takes 1 second to migrate the state information item Sp-1 or Sp-2 of one server 103-j and each server 103-j needs to migrate the state information item Sp-1 or Sp-2 one by one in turn. In this case, (3α−2), which is the maximum number N of the servers 103-j to be subjected to the state information rearrangement, needs to be equal to or smaller than N=10. Accordingly, it suffices if the value of the minimum member server count α is set to “4” based on the relationship of “3α−2=10”.

Through Step S801 described above, the control apparatus 101 creates in the redundancy group information 600 as many entries as the redundancy group count G, and assigns the redundancy group numbers to the created entries.

Next, after setting the redundancy group count G in Step S801, the control apparatus 101 determines the redundancy group 104-g to which each of the servers 103-1 to 103-N is to belong this group is hereinafter referred to as “associated group”) (Step S802). Specifically, for example, the control apparatus 101 assigns as many servers 103-j as the minimum member server count α to each of the redundancy groups 104-1 to 104-G so that the difference in the number of assigned servers 103-j (server count) among the redundancy groups 104-g is minimized. When the server count is not divisible by the minimum member server count α, the control apparatus 101 assigns, to any one of the redundancy groups 104-g, as many servers 103-j as a remainder obtained by dividing the server count by the minimum member server count α.

As an example of a method of determining the associated group of each of the servers 103-1 to 103-N, the control apparatus 101 may use the following method. Specifically, the control apparatus 101 repeats processing of assigning the remaining servers 103-j one by one in order from the redundancy group 104-1 on a round-robin basis until all the remaining servers 103-j are assigned to the redundancy groups 104-g. For example, when the control apparatus 101 determines the redundancy groups 104-g as the associated groups of 11 servers 103-1 to 103-11 based on the minimum member server count α of “3”, the control apparatus 101 assigns 3 servers to each of the redundancy groups 104-1 to 104-3 because the redundancy group count is “3”, which is a quotient obtained by dividing “11” by “3”. The control apparatus 101 then assigns one of the remaining two servers 103-j to the redundancy group 104-1, and assigns the other server to the redundancy group 104-2.

Through Step S802 described above, for each of the entries of the redundancy group information 600, the control apparatus 101 can set the member server count and the member server number of the redundancy group information 600. It should be noted that the determination method is not limited to a method of determining the associated groups on a round-robin basis, and the control apparatus 101 may determine the associated groups of the servers 103-j at random, or may determine those associated groups by assigning the servers 103-j to a given specific redundancy group 104-g in a concentrated manner. For example, in the above-mentioned example, the control apparatus 101 may determine the redundancy group 104-g as the associated group of the servers 103-1 to 103-9, the redundancy group 104-2 as the associated group of the server 103-10, and the redundancy group 104-3 as the associated group of the server 103-11.

Then, the control apparatus 101 determines, from among the redundancy groups 104-1 to 104-G, assignment destinations of the state information items Sp-1 and Sp-2 on the session group specified by the assigned session group number (Step S803). Specifically, for example, the control apparatus 101 determines the assignment destinations of the state information items Sp-1 and Sp-2 from among the redundancy groups 104-1 to 104-G so that the difference, in the number of the assigned state information items Sp-1 and Sp-2 among the redundancy groups 104-g is minimized. The total number of session groups, namely, the maximum value of the session group number p, is the same as the total number of hash values that can be output from the hash function 121. The control apparatus 101 assigns the assigned session groups of the redundancy group as equally as possible so that the processing loads are distributed among the redundancy groups 104-g. To this end, the control apparatus 101 determines a quotient obtained by dividing the total number of session groups by the redundancy group count G as the number of assigned session groups.

Further, when the total number of session groups is not divisible by the redundancy group count G, the control apparatus 101 assigns to any one of the redundancy groups as many session groups as a remainder obtained by dividing the total number of session groups by the redundancy group count G. As an example of an assignment method, the control apparatus 101 can use a method of assigning the remaining session groups to the redundancy group 104-G haying the largest value as its branch number.

For example, when the control apparatus 101 assigns 500 session groups to 3 (G=3) redundancy groups 104-1 to 104-3, the division of “500” by “3” results in a quotient of “166” and a remainder of “2”. Accordingly, the control apparatus 101 assigns session groups corresponding to session group numbers p=1 to 166 to the redundancy group 104-1, session groups corresponding to session group numbers p=167 to 332 to the redundancy group 104-2, session groups corresponding to session group numbers p=333 to 498 to the redundancy group 104-3, and two session groups corresponding to remaining session group numbers p=499 and 500 to the redundancy group 104-3 having the largest value as its branch number.

Through Step S803 described above, for each of the entries of the redundancy group information 600, the control apparatus 101 can set the assigned session group number of the redundancy group information 600. It should be noted that the control apparatus 101 may determine the assignment destinations of the session groups at random, or may determine those assignment destinations by assigning the session groups to a given specific redundancy group 104-g in a concentrated manner. For example, in the above-mentioned example, the control apparatus 101 may assign the session groups corresponding to the session group numbers p=1 to 498 to the redundancy group 104-1, the session group corresponding to the session group number p=499 to the redundancy group 104-2, and the session group corresponding to the session group number p=500 to the redundancy group 104-3.

After that, the control apparatus 101 executes the assigned session group changing processing on the servers 103-j included in each of the redundancy groups 104-g (Step S804). Specifically, for example, the control apparatus 101 determines a given server 103-j as the assignment destination of the session groups assigned to the redundancy group 104-g to which the given server 103-j belongs. Each of the servers 103-j is in charge of processing for a packet of a given one of the session groups, and is also in charge of processing of storing in the operational data set R1-j the state information items Sp-1 that is the result of processing the packet.

There is known a round robin method as a method of determining the assignment destination server of the session group. In the round robin method, in order from the session group 1, the session groups are assigned to the server 103-1, the server 103-2, the server 103-3, . . . , which are included in the redundancy group 104-g, in order. The round robin method has an advantage in that the session groups can be equally assigned to the servers 103-j with a simple method.

Further, as another example of the method of determining the assignment destination server of the session group, there is a method of determining, in consideration of the difference in processing performance among the servers 103-j (e.g., a clock frequency of the processor or a memory capacity), the server 103-j having higher processing performance as the assignment destination of the larger number of session groups. This determination method has an advantage in that if there is a difference in processing performance among the servers 103-1, the load distribution suited to the processing performance of the server 103-j can be achieved and thus the difference in processing load among the servers 103-1 can be suppressed. Those determination methods are merely examples, and any method can be used as long as the method involves determining each of the assignment destination servers of the session groups from among the servers 103-j included in the same redundancy group 104-g. For example, the control apparatus 101 may determine the assignment destinations of the session groups at random, or may determine those assignment destinations by assigning the session groups to a given specific server 103-j in a concentrated manner.

After that, the control apparatus 101 executes redundant system construction processing on the redundancy group 104-g, and each of the servers 103-j determines the session group to be in charge of storing of the redundant data. Through determination of another server 103-k (j≠k) as the assignment destination of the session group to be processed by each of the servers 103-j, each of the servers 103-j determines the session group to be in charge of storing of the redundant data.

For example, when the server 103-1 is in charge of the processing for the session groups 1, 2, and 3, the redundant data items are distributed as follows. Specifically, the server 103-2 is in charge of the storing of the redundant data (state information item S1-2) of the session group 1, the server 103-3 is in charge of the storing of the redundant data (state information item S2-2) of the session group 2, and the server 103-4 is in charge of the redundant data (state information item S3-2) of the session group 3. In this manner, when the server 103-1 is removed due to a failure, the remaining three servers 103-2 to 103-4 can take over the processing of the removed server 103-1. This method is merely an example, and any method can be used as long as the method involves determining the roles of the respective servers, namely, the server in charge of the operational data and the server in charge of the redundant data, from among the servers 103-j included in the same redundancy group.

Through Step S804 described above, the control apparatus 101 can generate the session group information 700 shown in FIG. 7.

After that, the control apparatus 101 assigns the state information items to the servers 103-j based on the session group information 700 generated in Step S804 (Step S805). With this, the initial configuration processing for the redundancy group ends.

<Example of State Information Rearrangement and Redundancy Group Division at the Time of Server Addition>

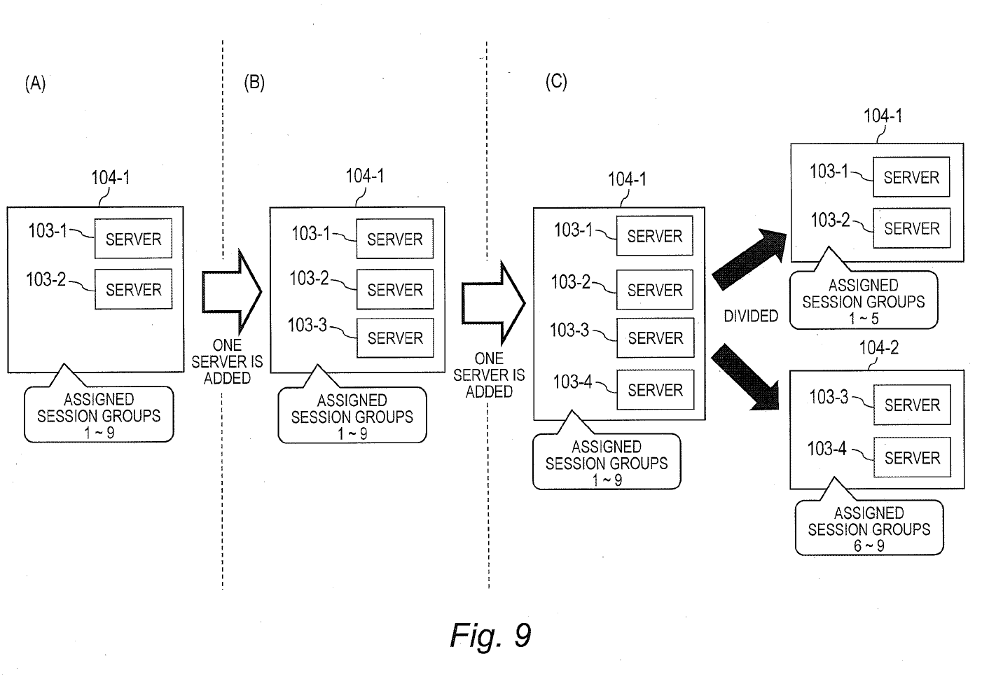

Referring to FIG. 9 to FIG. 18, a description is given of an example of state, information rearrangement and redundancy group division at the time of server addition. The member server count of the redundancy group 104-g changes after the addition or removal of the server 103-j. When the member server count of a given redundancy group 104-g becomes 2α as a result of the addition of the server 103-j to a given redundancy group 104-g, the control apparatus 101 divides the given redundancy group 104-g into two redundancy groups. Accordingly, the maximum member server count of each redundancy group 104-9 is (2α−1), and the maximum number of the servers 103-j in which the state information items Sp-1 and Sp-2 are to be rearranged at the time of addition of the server 103-j is 2α.

A reason why the redundancy group 104-j is divided at the time of addition of the server 103-j is to prevent, after the member server count of the given redundancy group 104-g continues to increase, the servers of the given redundancy group 104-g from accounting for the most part of the total number N of servers of the management system 100. In this manner, the load distribution can be achieved among the redundancy groups 104-g. It should be noted that the minimum member server count α is set to α=2. Further, under an initial state, the redundancy group count G is set to G=1.

FIG. 9 is an explanatory diagram illustrating an example of a change of the redundancy group at the time of the server addition. Part (A) of FIG. 9 illustrates a state before the server addition. Part (B) of FIG. 9 illustrates an example in which under the state of part (A) of FIG. 9, the server 103-3 is added to the redundancy group 104-1. Part (C) of FIG. 9 illustrates an example in which under the state of part (B) of FIG. 9, the server 103-4 is added to the redundancy group 104-1, and the redundancy group 104-1 is then divided.

In part (B) of FIG. 9, when the server 103-3 is added under the state of part (A) of FIG. 9, the member server count of the redundancy group 104-1 becomes “3”, However, the member server count does not become equal to 2α (=4), which is twice as large as the minimum member server count α (=2). The redundancy group 104-1 is therefore not divided yet.

In part (C) of FIG. 9, when the server 103-4 is added under the state of part (B) of FIG. 9, the member server count of the redundancy group 104-1 becomes “4”. The member server count thus becomes equal to 2α which is twice as large as the minimum member server count α (=2). The control apparatus 101 therefore divides the redundancy group 104-1 into two redundancy groups 104-1 and 104-2. In this case, the redundancy group 104-1 after the division includes the servers 103-1 and 103-2, and the redundancy group 104-2 after the division includes the servers 103-3 and 103-4.

Further, the assigned session groups before the division corresponding to the state of part (B) of FIG. 9 are 1 to 9, but through the division, the redundancy group 104-1 after the division holds the state information items S1-1 to S5-1 and S1-2 to S5-2 of the assigned session groups 1 to 5, and the redundancy group 104-2 after the division holds the state information items S6-1 to S9-1 and S6-2 to S9-2 of the assigned session groups 6 to 9. In this manner, when the member server count becomes 2α in one redundancy group 104-g, this redundancy group 104-g is divided into two redundancy groups.

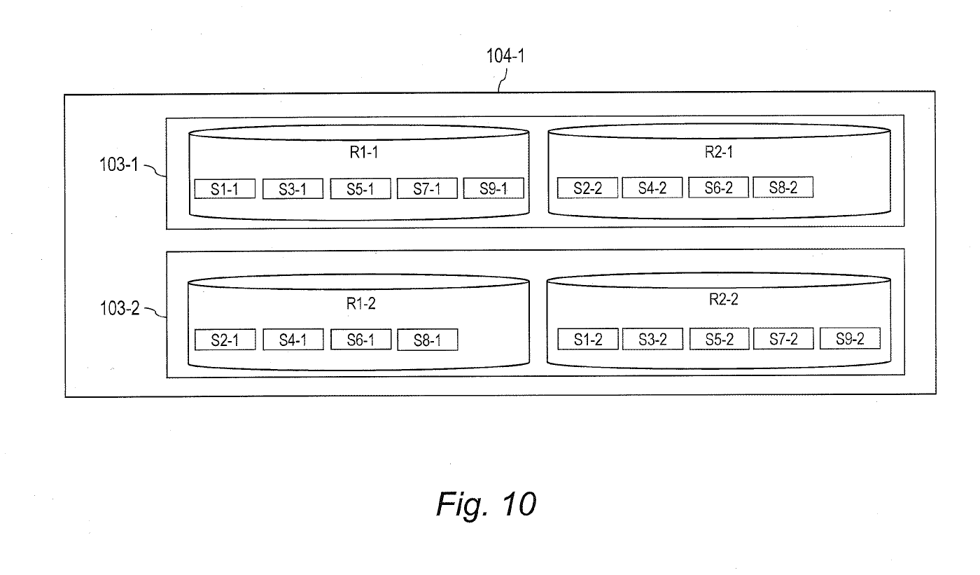

FIG. 10 is an explanatory diagram illustrating the redundancy groups before the server addition. FIG. 10 illustrates the state of part (A) of FIG. 9, The redundancy group 104-1 includes the servers 103-1 and 103-2.

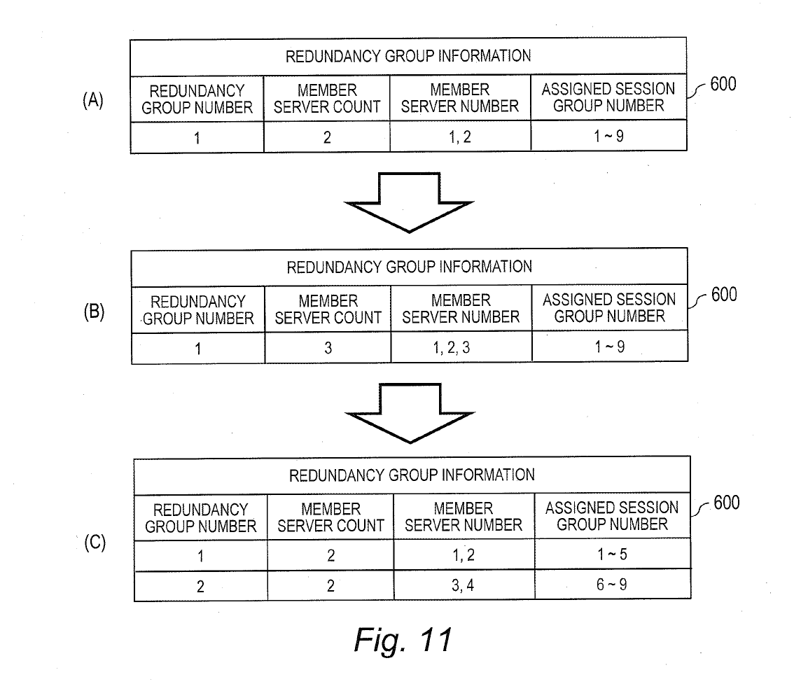

FIG. 11 is an explanatory diagram showing an update example of the redundancy group information 600. Part (A) of FIG. 11 shows the redundancy group information 600 under the initial state, namely, the state of part (A) of FIG. 9 and FIG. 10. Part (B) of FIG. 11 shows the redundancy group information 600 at the time when under the state of part (A) of FIG. 9, the server 103-3 is added so that this state reaches the state of part (B) of FIG. 9. Part (C) of FIG. 11 shows the redundancy group information 600 at the time when under the state of part (B) of FIG. 9, the server 103-4 is added and the redundancy group 104-1 is divided so that this state reaches the state of part (C) of FIG. 9.

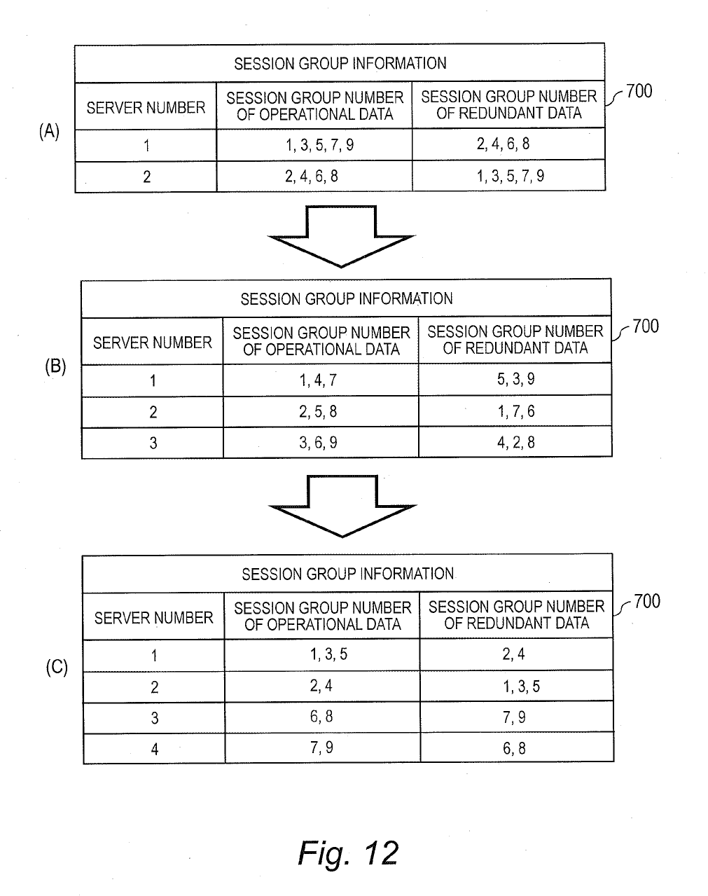

FIG. 12 is an explanatory diagram showing an update example of the session group information 700. Part (A) of FIG. 12 shows the session group information 700 under the initial state, namely, the state of part (A) of FIG. 9 and FIG. 10, Part (B) of FIG. 12 shows the session group information 700 at the time when under the state of part (A) of FIG. 9, the server 103-3 is added so that this state reaches the state of part (13) of FIG. 9. In part (B) of FIG. 11, the member servers of the redundancy group 104-1 are the servers 103-1 to 103-3. Accordingly, in part (B) of FIG. 12, for example, through the processing of Step S803, the control apparatus 101 assigns the session group numbers “1” to “9” on a round-robin basis in the entries having the server numbers “1”, “2”, and “3”.

Part (C) of FIG. 12 shows the session group information 700 at the time when under the state of part (B) of FIG. 9, the server 103-4 is added and the redundancy group 104-1 is divided so that this state reaches the state of part (C) of FIG. 9. In part (C) of FIG. 11, the member servers of the redundancy group 104-1 are the servers 103-1 and 103-2. Accordingly, in part (C) of FIG. 12, the control apparatus 101 assigns the session group numbers “1” to “5” on a round-robin basis in the entries having the server numbers “1” and “2”. In the same manner, the control apparatus 101 assigns the session group number “6” to “9” in the entries having the server numbers “3” and “4” on a round-robin basis.

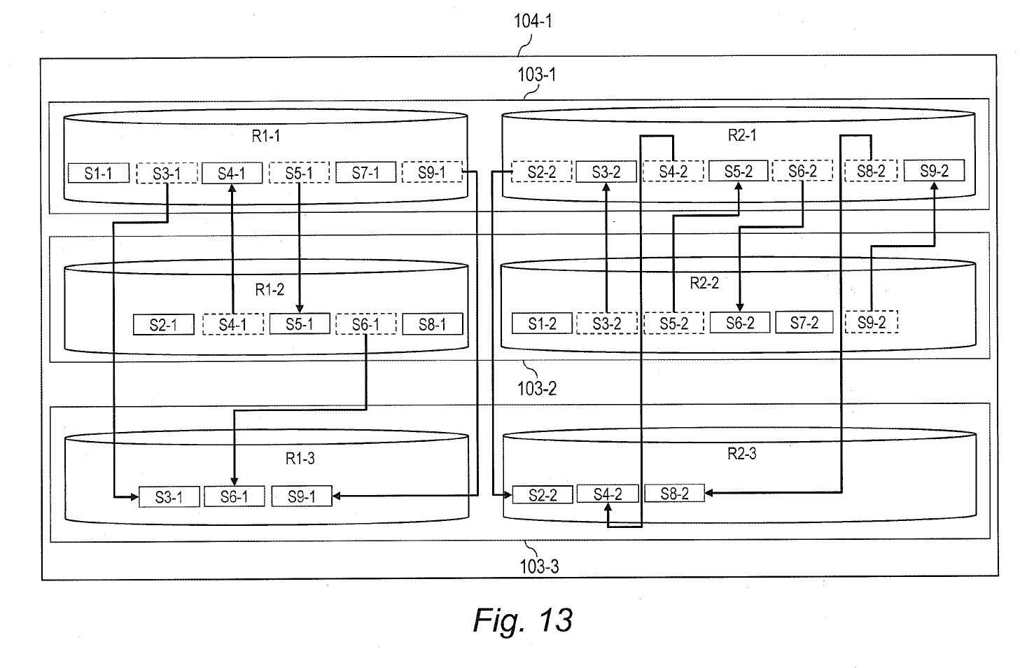

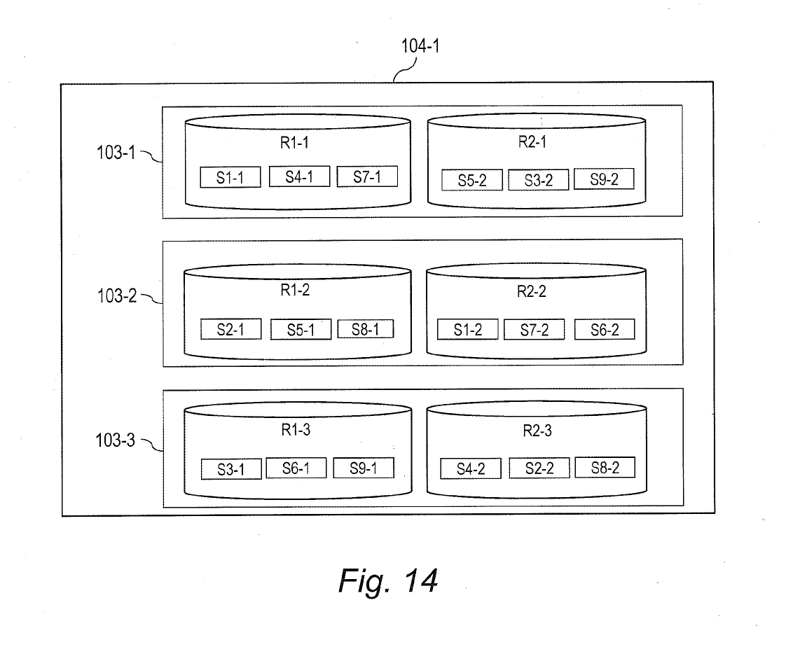

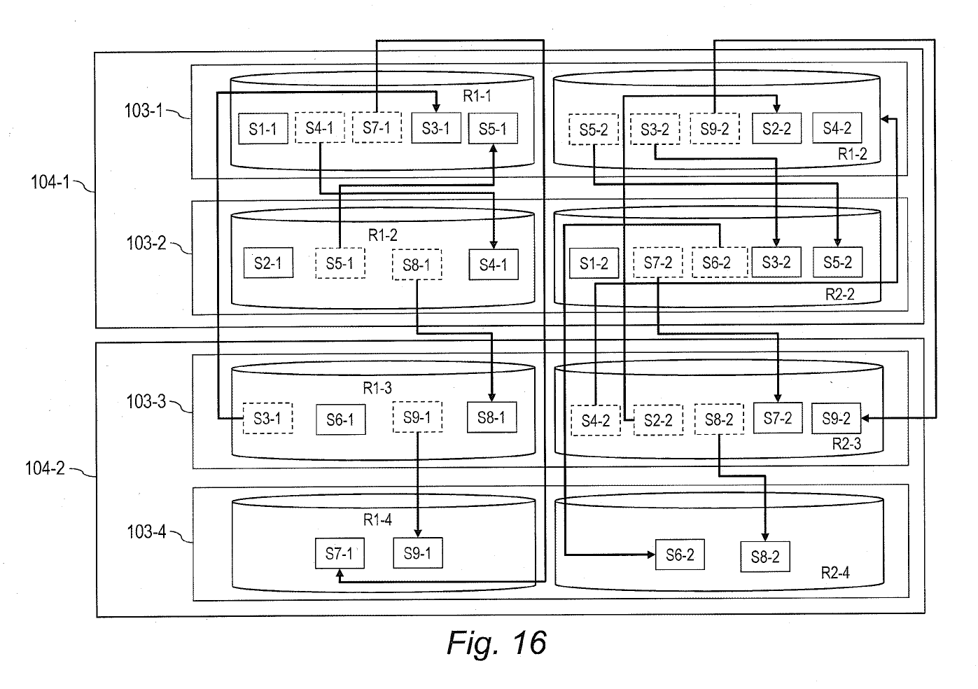

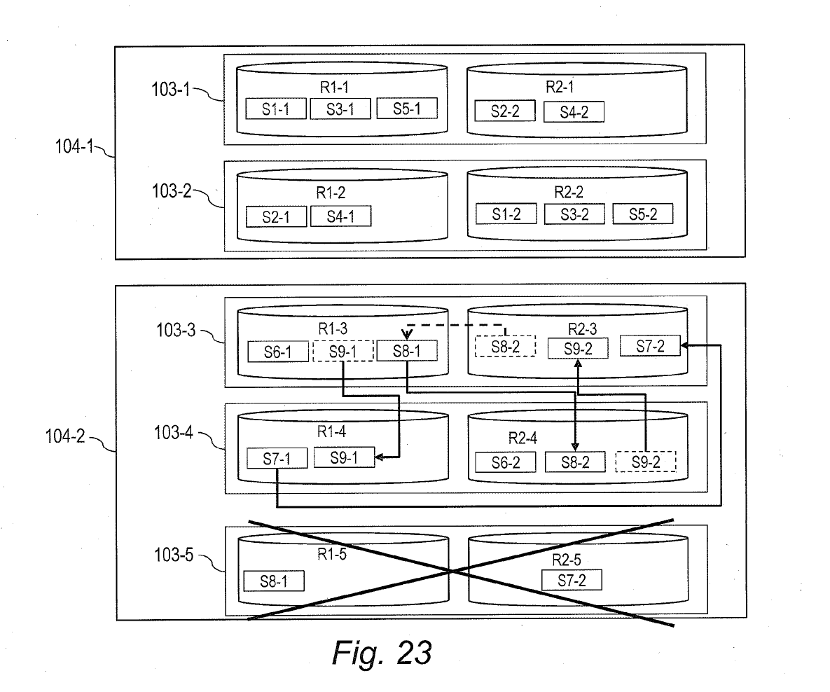

FIG. 13 is an explanatory diagram illustrating State Information Rearrangement Operation Example 1 at the time of server addition. FIG. 14 is an explanatory diagram illustrating State Information Rearrangement Operation Result 1 at the time of server addition. The rearrangement operation illustrated in FIG. 13 is an operation example at the time when the server is added so that the state of part (A) of FIG. 9 reaches the state of part (B) of FIG. 9, and is executed based on the session group information 700 of part (B) of FIG. 12. In FIG. 13 (the same holds true for FIG. 16 and FIG. 23), the thick arrows indicate the migration of the state information items Sp-1 and Sp-2, and the broken-line rectangle on the start side of each thick arrow is the state information item Sp-1 or Sp-2 in the migration source. After the migration, this state information item Sp-1 or Sp-2 is removed from the operational data set R1-j or the redundant data set R2-j as the migration source. The rectangle on the end side of each thick arrow is the state information item Sp-1 or Sp-2 that has been migrated from the operational data set R1-j or the redundant data set R2-j as the migration source.

As described above, the rearrangement of the state information is executed within one redundancy group 104-1, and hence in a case where there is another redundancy group 104-g even when a failure occurs in the redundancy group 104-1 at the time of the rearrangement of the state information, the influence of the failure does not spread to affect the another redundancy group 104-g.

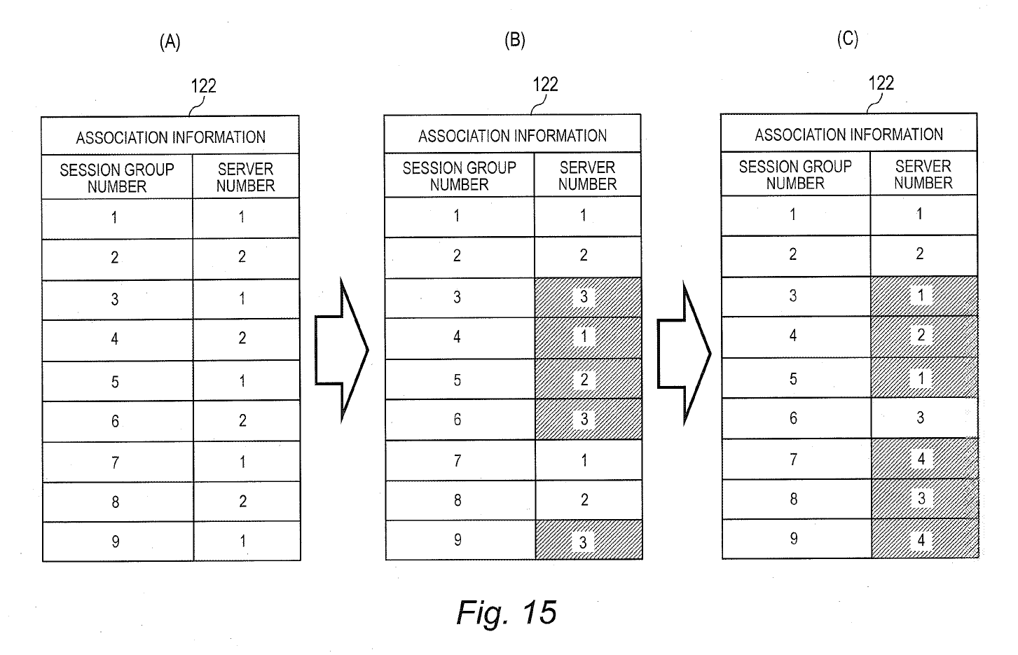

FIG. 15 is an explanatory diagram showing an update example of the association information 122. The control apparatus 101 updates the association information 122 held by each load distribution apparatus 102-i from the state of part (A) of FIG. 15 to that of part (B) of FIG. 15, and then updates the association information 122 from the state of part (B) of FIG. 15 to that of part (C) of FIG. 15. Part (A) of FIG. 15 shows the association information 122 under the initial state, namely, the state of part (A) of FIG. 9 and FIG. 10. Part (B) of FIG. 15 shows the association information 122 at the time when under the state of part (A) of FIG. 9, the server 103-3 is added so that this state reaches the state of part (B) of FIG. 9. This association information 122 is updated based on the session group information 700 shown in part (B) of FIG. 12. Part (C) of FIG. 15 shows the association information 122 at the time when under the state of part (B) of FIG. 9, the server 103-4 is added and the redundancy group 104-1 is divided so that this state readies the state of part (C) of FIG. 9. This association information 122 is updated based on the session group information 700 shown in part (C) of FIG. 12.

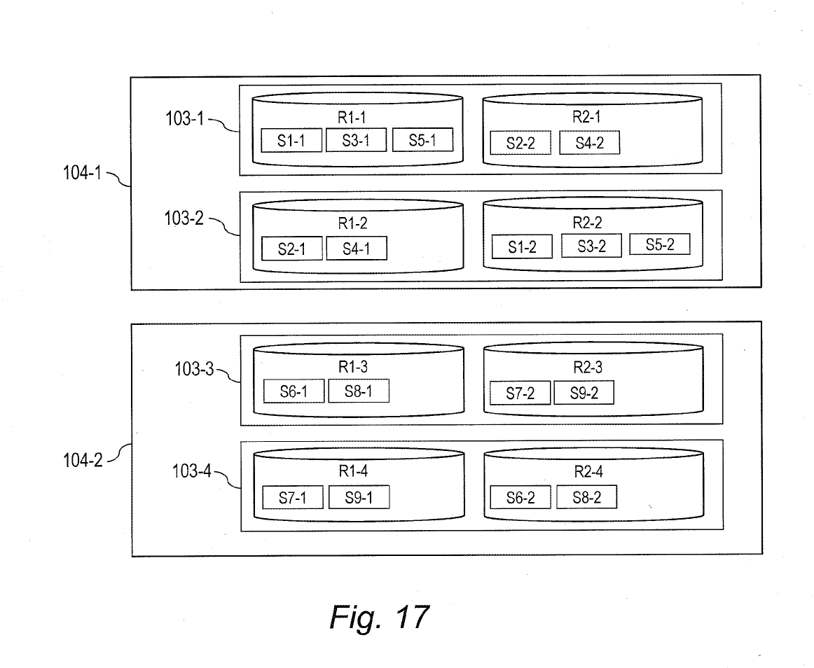

FIG. 16 is an explanatory diagram illustrating State Information Rearrangement Operation Example 2 at the time of server addition. FIG. 17 is an explanatory diagram illustrating State Information Rearrangement Operation Result 2 at the time of server addition. The rearrangement operation illustrated in FIG. 16 is an operation example at the time when the server is added so that the state of part (B) of FIG. 9 reaches the state of part (C) of FIG. 9, and is executed based on the session group information 700 of part (C) of FIG. 12. As shown in part (C) of FIG. 9, when the redundancy group 104-1 is divided, the arrangement of the state information is executed on both of the redundancy groups 104-1 and 104-2 after the division. As described above, the redundancy group 104-9 is divided each time its member server count reaches 2α after the server is added thereto, and hence in any one of the redundancy groups 104-g, the server count of each redundancy group 104-g corresponding to the affected range of a failure can be suppressed within the range of from α to 2α−1.

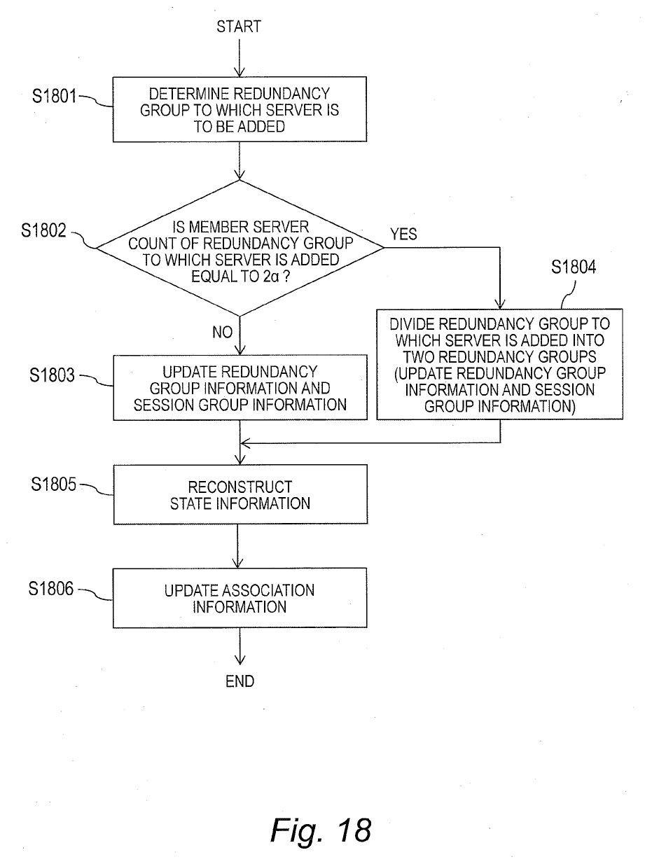

FIG. 18 is a flowchart illustrating Redundancy Group Update Processing Example 1 performed by the control apparatus 101. In the redundancy group update processing of FIG. 18, the assigned session group changing processing and redundant system reconstruction processing described above are executed.

When detecting that the server 103-(N+1) is added, the control apparatus 101 determines the redundancy group 104-g to which the server 103-(N+1) is to be added based on the member server count of each redundancy group 104-g, which is stored in the redundancy group information 600 (Step S1801). For example, in the case of parts (A) and (B) of FIG. 9, the management system 100 includes only the redundancy group 104-1, and hence the control apparatus 101 determines the redundancy group 104-1 as the redundancy group to which the server is to be added. When the management system 100 includes a plurality of redundancy groups 104-g, the control apparatus 101 determines the redundancy group 104-g having the smallest member server count as the redundancy group to which the server is to be added.

Next, the control apparatus 101 determines whether or not the member server count of the redundancy group 104-g to which the server 103-(N+1) is added is equal to 2α, which is twice as large as the minimum member server count α (Step S1802). When the member server count is not equal to 2α (Step S1802: No), the processing proceeds to Step S1803. For example, in part (A) of FIG. 9, the member server count of the redundancy group 104-1 after the addition of the server 103-3 is “3”, and hence this member server count is not equal to 2α (=4), which is twice as large as the minimum member server count α (Step S1802: No).

When the member server count after the server addition is not equal to 2α (Step S1802: No), such as in the above-mentioned case, as shown in parts (A) and (B) of FIG. 11, the control apparatus 101 updates the redundancy group information 600 from the state of part (A) of FIG. 11 to that of part (B) of FIG. 11 (Step S1803). In this case, the redundancy group 104-1 is not divided, and hence no new entry is generated in the redundancy group information 600. In the redundancy group information 600, the member server count of the entry having the redundancy group number “1” is updated from “2” to “3”, and “3” is added as the member server number of this entry.

Further, as shown in parts (A) and (B) of FIG. 12, the control apparatus 101 updates the session group information 700 from the state of part (A) of FIG. 12 to that of part (B) of FIG. 12. In order to update the session group information 700, the processing illustrated in Step S804 of FIG. 8 is executed, for example. As shown in part (B) of FIG. 12, the control apparatus 101 generates an entry for the added server 103-3 (server number “3”), and assigns, in the entries having the server numbers “1” to “3, the session group number of the operational data and the session group number of the redundant data on a round-robin basis. In this case, the session group numbers are assigned so that the same session group number of the operational data as that of the redundant data is not assigned redundantly in the same entry. Then, the processing proceeds to Step S1805.

On the other hand, in Step S1802, when the member server count of the redundancy group 104-g to which the server 103-(N−1) is added is equal to 2α, which is twice as large as the minimum member server count α (Step S1802: Yes), the processing proceeds to Step S1804. For example, in the example of part (B) of FIG. 9, the member server count of the redundancy group 104-1 after the addition of the server 103-4 is “4”, and is therefore equal to 2α (=4), which i twice as large as the minimum member server count α (Step S1802: Yes).

Accordingly, as illustrated in part (C) of FIG. 9, the control apparatus 101 divides the redundancy group 104-1 to which the server 103-(N+1) is added into two redundancy groups 104-1 and 104-2 (Step S1804). Specifically, the control apparatus 101 updates the redundancy group information 600 from the state of part (B) of FIG. 11 to that of part (C) of FIG. 11. In this case, the redundancy group 104-1 is divided, and hence a new entry having a redundancy group number “2” is generated in the redundancy group information 600. The servers are equally assigned to each of the redundancy groups so that the entries having the redundancy group numbers “1” and “2” have the same member server count, and the member server numbers are also equally assigned to each of the redundancy groups so that those entries have the same number of member server numbers.

Further, the control apparatus 101 updates the session group information 700 from the state of part (B) of FIG. 12 to that of part (C) of FIG. 12. In this case, as shown in part (C) of FIG. 12, the control apparatus 101 generates an entry for the added server 103-4 (server number “4”), and based on the redundancy group information 600 of part (C) of FIG. 11, the control apparatus 101 assigns, in the entries having the server numbers “1” and “2”, the session group number of the operational data and the session group number of the redundant data on a round-robin basis. In this case, the session group numbers are assigned so that the same session group number of the operational data as that of the redundant data is not assigned redundantly in the same entry. In the same manner, based on the redundancy group information 600 of part (C) of FIG. 11, the control apparatus 101 assigns, in the entries having the server numbers “3” and “4”, the session group number of the operational data and the session group number of the redundant data on a round-robin basis. Then, the processing proceeds to Step S1805.

After that, the control apparatus 101 reconstructs the state information based on the updated session group information 700 as illustrated in FIG. 13 and FIG. 16 (Step S1805). Specifically, for example, the control apparatus 101 transmits, to each server 103-j, the entry corresponding to the each server 103-j among the entries of the session group information 700 to control the each server 103-j to reconstruct the state information. Further, as shown in FIG. 15, the control apparatus 101 updates, based on the updated session group information 700, the association information 122 held by each load distribution apparatus 102-i (Step S1806). With this, the redundancy group update processing ends.

As described above, at the time of the rearrangement of the state information after the addition of the server 103-(N+1), even when a failure occurs in the redundancy group 104-g to which the server 103-(N+1) is added, the failure does not spread to affect another redundancy group. it is therefore possible to minimize the damage of the failure. Further, when the number of the servers 103-j included in the redundancy group 104-g increases to reach a predetermined value (e.g., 2α), the redundancy group 104-g is divided. It is therefore possible to suppress the expansion of the affected range of the failure.

Next, a description is given of processing performed when the server is removed. When the server 103-j is removed from the redundancy group 104-g, the management system uses the redundant data held by the remaining server 103-j (j≠k) to take over processing that is based on the operational data of the removed server 103-k. Further, because the redundant data of tin server 103-j is changed to the operational data, there is no longer redundant data of this operational data. Therefore, the management system 100 needs to reconstruct the redundant data in preparation for server removal that may occur thereafter. Further, when the member server count of the redundancy group 104-g becomes smaller than the minimum member server count α due to the server removal, the management system 100 merges this redundancy group 104-g with another redundancy group.

<Example of State Information Rearrangement and Redundancy Group Division at the Time of Server Removal>

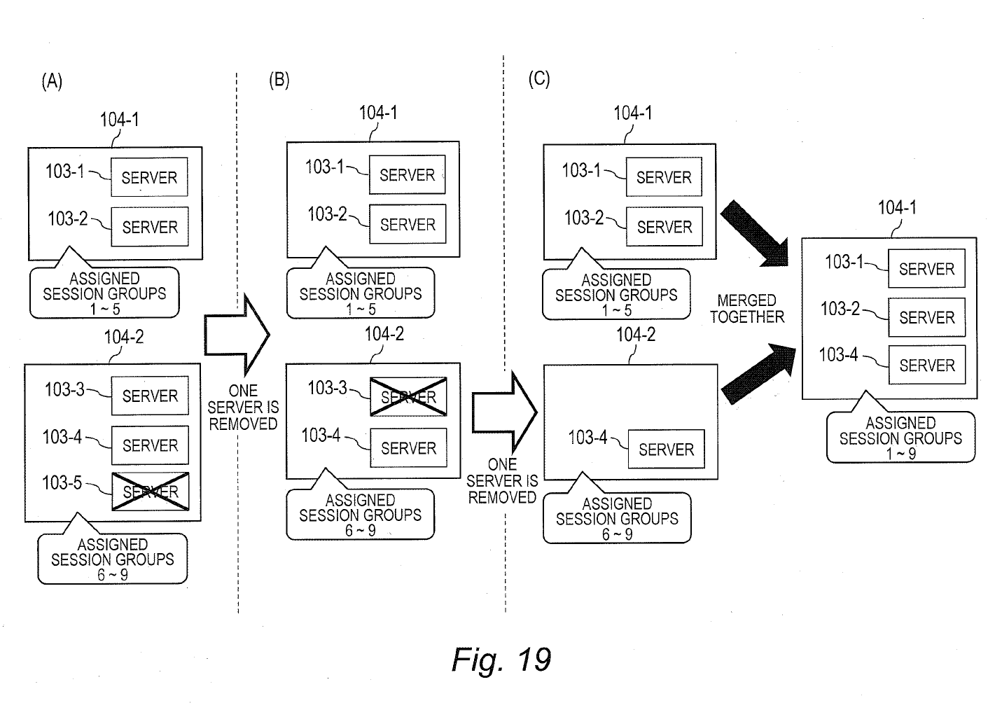

Next, referring to FIG. 19 to FIG. 27, a description is given of an example of state information rearrangement and redundancy group division at the time of server removal. After the server 103-j is removed from a given redundancy group 104-g, when the member server count of the given redundancy group 104-g becomes smaller than α, the control apparatus 101 merges the given redundancy group 104-g with another redundancy group 104-h (h≠g). Accordingly, the minimum member server count of each redundancy group 104-g is (α−1), and the maximum number of the servers 103-j whose state information items Sp-1 and Sp-2 are to be rearranged at the time of removal of the server 103-j is (3α−2), which is satisfied when the redundancy group 104-g having the member server count of (α−1) and the redundancy group 10-h (h≠g) having the member server count of (2α−1) are merged together.

A reason why the redundancy group 104-g is merged with another redundancy group 104-h (h≠g) at the time of removal of the server 103-j is to prevent a case where, after the member server count of a given redundancy group 104-g continues to decrease, the member server count of the given redundancy group 104-g becomes “1” and thus the redundant system cannot be constructed within the given redundancy group 104-g. Accordingly, when the server 103-j is added or removed, the maximum number of the servers 103-j whose state information items Sp-1 and Sp-2 are to be rearranged is (3α−2). The minimum member server count α is set to α=2. Further, under the initial state, the redundancy group count G is set to G=2.

FIG. 19 is an explanatory diagram illustrating an example of a change of the redundancy group at the time of the server removal. Part (A) of FIG. 19 illustrates a state before the server removal. Part (B) of FIG. 19 illustrates an example in which under the state of part (A) of FIG. 19, the server 103-5 is removed from the redundancy group 104-2. Part (C) of FIG. 19 illustrates an example in which under the state of part (B) of FIG. 19, the server 103-3 is removed from the redundancy group 104-2, and the redundancy group 104-1 and the redundancy group 104-2 are merged together.

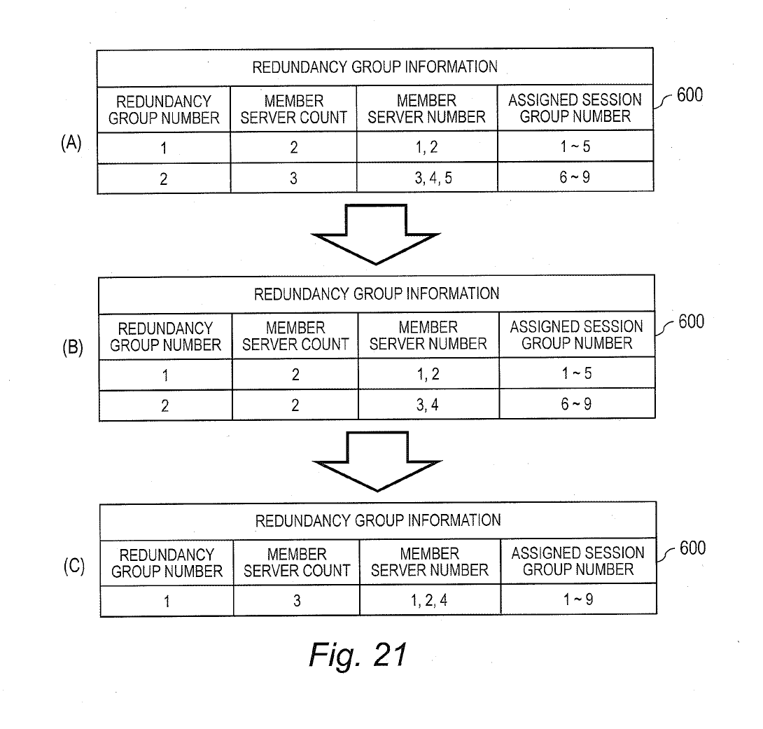

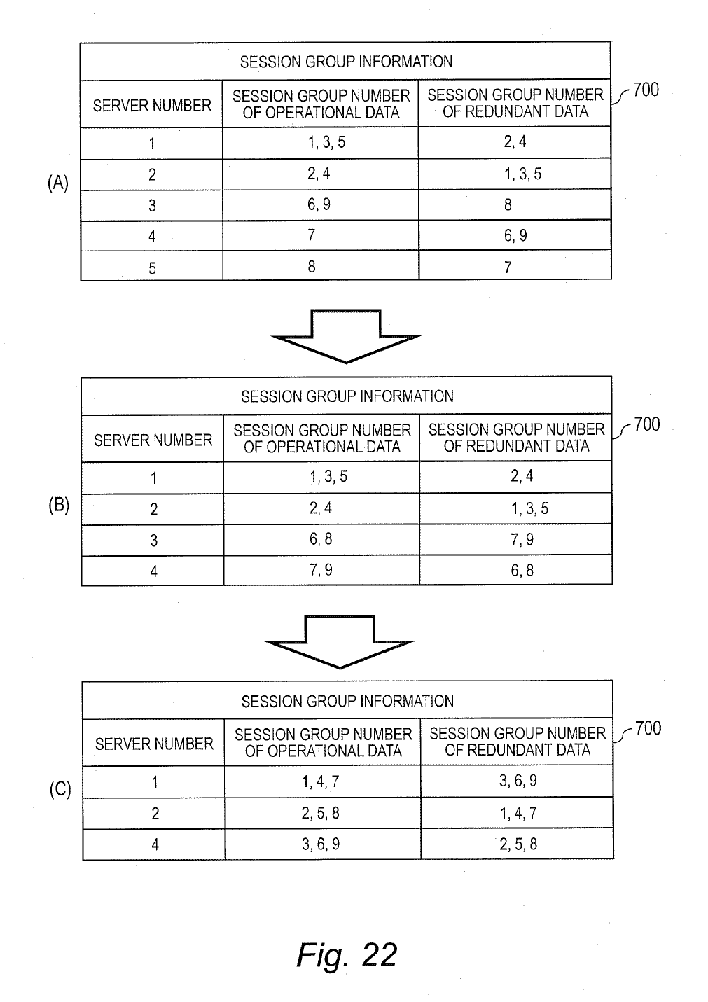

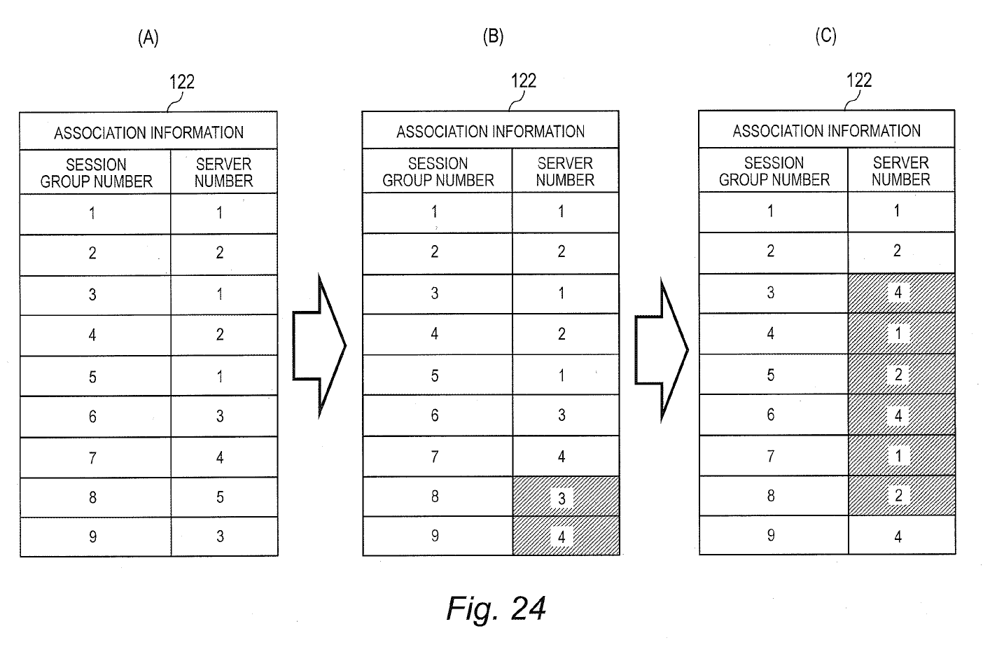

In part (B) of FIG. 19, when the server 103-3 is removed under the state of part (A) of FIG. 19, the member server count of the redundancy group 104-2 decreases from “3” to “2”, and hence the member server count does not fall below the minimum member server count α (=2). Accordingly, the redundancy group 104-2 is not merged with another redundancy group, namely, the redundancy group 104-1. in this case, in the redundancy group 104-2, as shown in parts (A) and (B) of each of FIG. 21 and FIG. 22 and parts (A) and (B) of FIG. 24, which are described later, the state information items Sp-1 and Sp-2 are rearranged within the redundancy group 104-2. Therefore, even when a failure occurs in the redundancy group 104-2 during the rearrangement, the failure does not spread to affect the redundancy group 104-1.

In part (C) of FIG. 19, when the server 103-3 is removed under the state of part (B) of FIG. 19, the member server count of the redundancy group 104-2 decreases from “2” to “1”, and hence the member server count falls below the minimum member server count α (=2). Accordingly, the redundancy group 104-2 is merged with an redundancy group, namely, the redundancy group 104-1. Further, the redundancy group 104-1 after the merging now holds the state information items S1-1 to S9-1 and S1-2 to S9-2 of the assigned session groups 1 to 9. As described above, when the member server count falls below α in one redundancy group 104-g, this redundancy group 104-g is merged with another redundancy group.

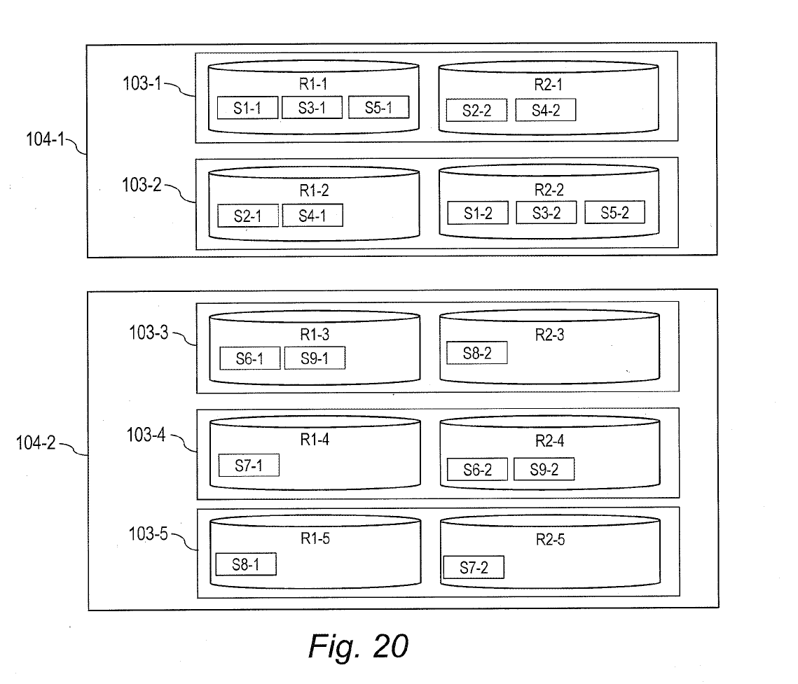

FIG. 20 is an explanatory diagram illustrating the redundancy groups before the server removal. FIG. 20 illustrates the state of part (A) of FIG. 19. The redundancy group 104-1 includes the servers 103-1 and 103-2, and the redundancy group 104-2 includes the servers 103-3 to 103-5.

FIG. 21 is an explanatory diagram showing an update example of the redundancy group information 600. Part (A) of FIG. 21 shows the redundancy group information 600 under the initial state, namely, the states of part (A) of FIG. 19 and part (A) of FIG. 22. Part (B) of FIG. 21 shows the redundancy group information 600 at the time when the state of part (A) of FIG. 19 reaches the state of part (B) of FIG. 19. Part (C) of FIG. 21 shows the redundancy group information 600 at the time when under the state of part (B) of FIG. 19, the server 103-3 of the redundancy group 104-2 is removed, and then the redundancy groups 104-1 and 104-2 are merged together.

FIG. 22 is an explanatory diagram showing an update example of the session group information 700. Part (A) of FIG. 22 shows the session group information 700 under the initial state, namely, the states of part (A) of FIG. 19 and FIG. 20. Part (B) of FIG. 22 shows the session group information 700 at the time when under the state of part (A) of FIG. 19, the server 103-5 of the redundancy group 104-2 is removed. In other words, the entry having the server number “5” is removed. Then, for example, through the processing of Step S803, the control apparatus 101 assigns, in the entries having the remaining server numbers “1” to “4”, the session group numbers “1” to “9” on a round-robin basis.

Part (C) of FIG. 22 shows the session group information 700 at the time when under the state of part (B) of FIG. 19, the server 103-3 of the redundancy group 104-2 is removed, and then the redundancy groups 104-1 and 104-2 are merged together. In other words, the entry having the server number “3” is removed. In part (C) of FIG. 21, the member servers of the redundancy group 104-1 after the merging are the servers 103-1, 103-2, and 103-4. Accordingly, for example, through the processing of Step S804, the control apparatus 101 assigns, in the entries having the server numbers “1”, “2”, and “4”, the session group numbers “1” to “9” on a round-robin basis.

FIG. 23 is an explanatory diagram illustrating State Information Rearrangement Operation Example 1 at the time of server removal. FIG. 23 illustrates the redundancy groups 104-1 and 104-2 under the initial state, namely, at the time when the server 103-3 is removed in part (A) of FIG. 19. Through the removal of the server 103-5 from the redundancy group 104-2, the redundancy group 104-2 lacks the state information item S8-1 as the operational data and a state information item S7-2 as the redundant data, which have been held by the server 103-5. Accordingly, the remaining servers 103-3 and 103-4 of the redundancy group 104-2 reconstruct the state information based on the session group information 700 that is transmitted from the control apparatus 101 and shown in part (B) of FIG. 22.

Specifically, for example, the attribute of the state information item S8-2 included in the redundant data set R2-3 is changed from the redundant data to the operational data to become the state information item S8-1. In the same manner, a state information item S7-1 included in the operational data set R1-4 is replicated to the redundant data R2-3 to become the state information item S7-2.

Further, in order to equally assign the state information items between the servers 103-3 and 103-4, the state information item S9-1 held by the server 103-1 is migrated to the server 103-4. The state information item S8-1 obtained, through the attribute change is replicated, and the replicated state information item S8-1 is migrated to the redundant data set R2-4 of the server 103-4 as the state information item S8-2. In addition, the state information item S9-2 held by the server 103-4 is replicated to the redundant data set R2-3 of the server 103-3.

The rearrangement processing illustrated in FIG. 23 is executed within the redundancy group 104-2, and hence, even then a failure occurs in the redundancy group 104-2, the influence of the failure does not spread to affect the redundancy group 104-1.

FIG. 24 is an explanatory diagram showing an update example of the association information. The control apparatus 101 updates the association information 122 held by each load distribution apparatus 102-1 from the state of part (A) of FIG. 24 to that of part (B) of FIG. 24, and then updates the association information 122 from the state of part (B) of FIG. 24 to that of part (C) of FIG. 24. Part (A) of FIG. 24 shows the association information under the initial state, namely, the state of part (A) of FIG. 19 and part (A) of FIG. 20. Part (B) of FIG. 24 shows the association information at the time when under the state of part (A) of FIG. 19, the server 103-5 is removed so that this state reaches the state of part (B) of FIG. 19. This association information 122 is updated based on the session group information 700 shown in part (B) of FIG. 23. Part (C) of FIG. 24 shows the association information at the time when under the state of part (B) of FIG. 19, the server 103-2 is removed and the redundancy groups 104-1 and 104-2 are merged together so that this state reaches the state of part (C) of FIG. 19. This association information is updated based on the session group information 700 shown in part (C) of FIG. 23.

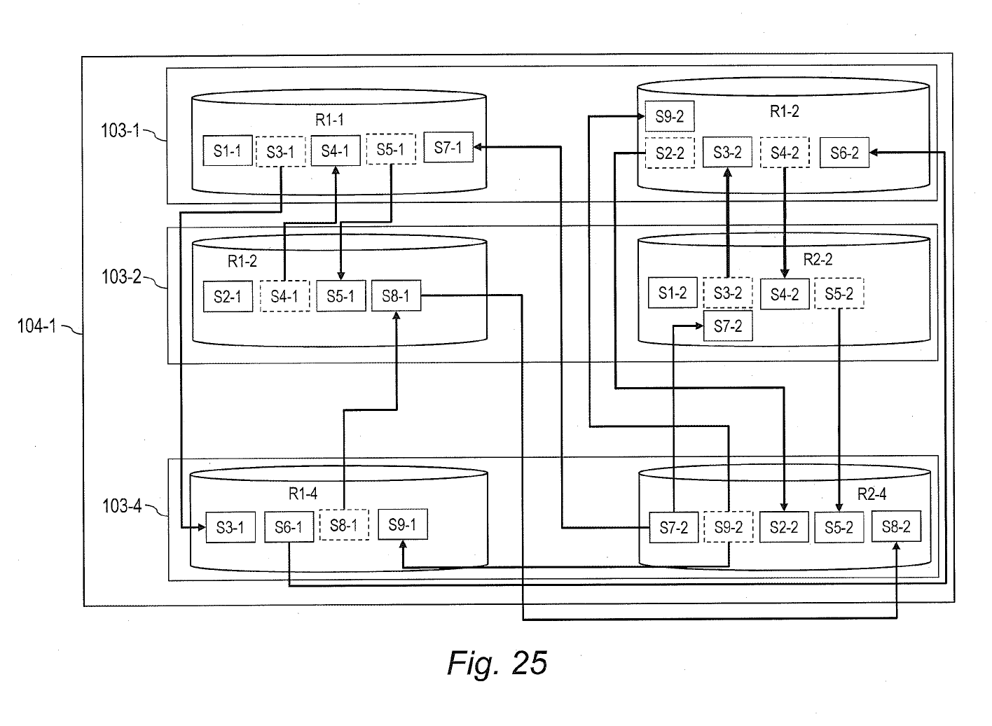

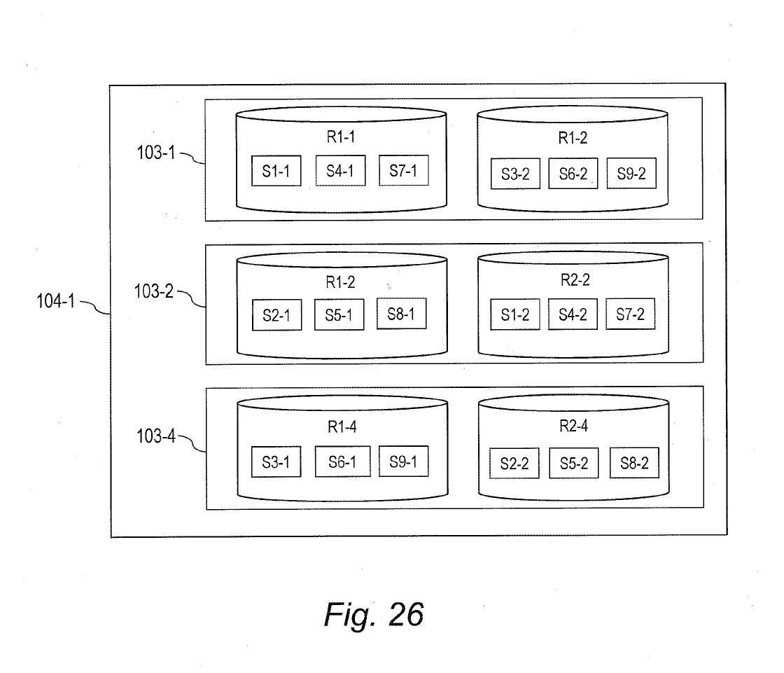

FIG. 25 is an explanatory diagram illustrating State Information Rearrangement Operation Example 2 at the time of server removal. FIG. 26 is an explanatory diagram illustrating a state information rearrangement operation result at the time of server removal of FIG. 25. The rearrangement operation illustrated in FIG. 25 is an operation example at the time when under the state of part (B) of FIG. 19, the redundancy groups 104-1 and 104-2 are merged together so that this state reaches the state of part (C) of FIG. 19, and is executed based on the session group information 700 of part (C) of FIG. 23.

As described above, the rearrangement of the state information is executed within one redundancy group 104-1, and hence in a case where there is another redundancy group 104-g, even when a failure occurs in the redundancy group 104-1 at the time of the rearrangement of the state information, the influence of the failure does not spread to affect the another redundancy group 104-g.

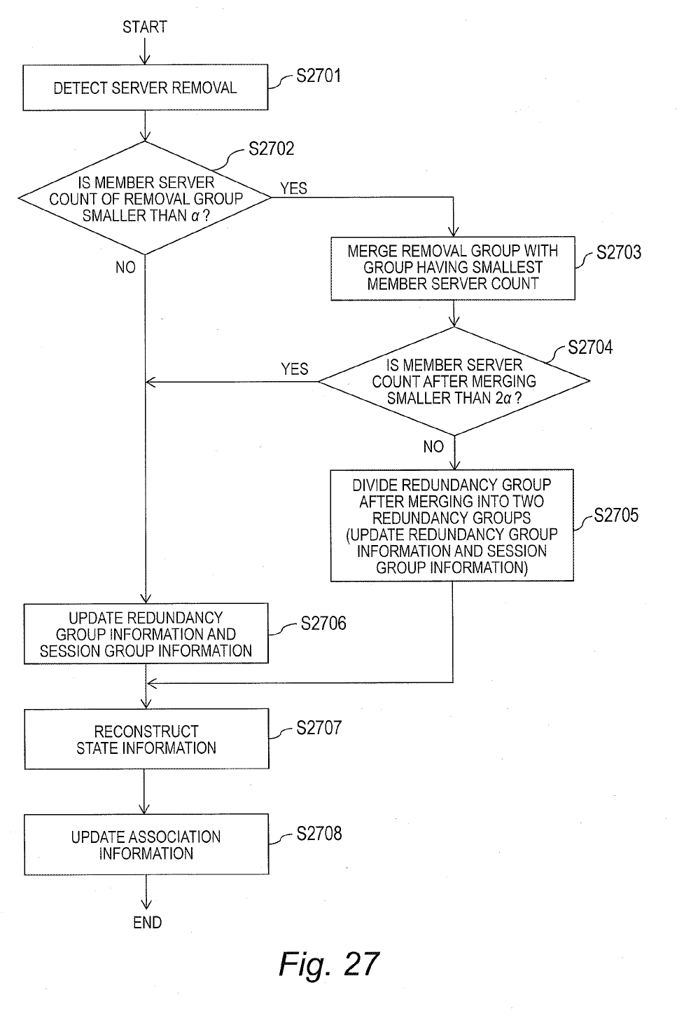

FIG. 2 is a flowchart illustrating Redundancy Group Update Processing Example 2 performed by the control apparatus 101. In the redundancy group update processing of FIG. 27, the assigned session group changing processing, failure recovery processing, and redundant system reconstruction processing described above are executed.

When detecting that the server 103-k is removed (Step S2701), the control apparatus 101 determines whether or not the member server count of the redundancy group 104-g from which the server 103-k has been removed (hereinafter referred to as “removal group”) is smaller than the minimum member server count α (Step S2702), When the member server count of the removal group is not smaller than α (Step S2702: No), there is no need to merge the removal group 104-g with another redundancy group, and hence the processing proceeds to Step S2706.

On the other hand, when the member server count of the removal group is smaller than α (Step S2702: Yes), the control apparatus 101 merges the removal group 104-g with another redundancy group (Step S2703). For example, the control apparatus 101 selects, as another redundancy group, the redundancy group that is different from the removal group and has the smallest member server count.

Then, the control apparatus 101 determines whether or not the member server count of the redundancy group 104-g after the merging is smaller than 2═, which is twice as large as the minimum member server count α (Step S2704). When the member server count of the redundancy group 104-g after the merging is smaller than 2α (Step S2704: Yes), there is no need to divide the redundancy group 104-g after the merging, and hence the processing proceeds to Step S2706. On the other hand, when the member server count of the redundancy group 104-g after the merging is not smaller than 2α (Step S2704: No), the control apparatus 101 divides the redundancy group 104-g after the merging into two redundancy groups (Step S2705). Then, the processing proceeds to Step S2707.

Further, in Step S2706, the control apparatus 101 updates the redundancy group information 600 and the session group information 700 (Step S2706). For example, the redundancy group information 600 is updated as follows. Specifically, when the removal group is not merged with another group, along with the removal of the server 103-j, in the entry of the removal group, the control apparatus 101 decrements the member server count by “1” and removes the server number of the removed server 103-j from the member server number. Further, when the removal group is merged with another group, for example, as shown in part (C) of FIG. 21, the control apparatus 101 combines the entry of the removal group with the entry of the redundancy group with which the removal group is merged.

Further, the session group information 700 is updated as follows. Specifically, along with the removal of the server 103-j, the control apparatus 101 removes the entry of the removed server 103-j from the session group information 700. For example, in the session group information 700 of part (A) of FIG. 22, when the server 103-5 is removed, the control apparatus 101 removes the entry having the server number “5” from the session group information 700 of part (A) of FIG. 22. Further, in the session group information 700 of part (B) of FIG. 22, when the server 103-3 is removed, the control apparatus 101 removes the entry having the server number “3” from the session group information 700 of part (B) of FIG. 22.

Then, when the removal group is not merged with another redundancy group, as shown in part (B) of FIG. 22, for example, through the processing illustrated in Step S803, the control apparatus 101 assigns the session group numbers “1” to “1” and the session group numbers “6” to “9” through use of the redundancy groups specified by part (B) of FIG. 21 as units of assignment.

Further, when the removal group is merged with another redundancy group, as shown in part (C) of FIG. 22, for example, through the processing illustrated in Step S803, the control apparatus 101 assigns the session group numbers “1” to “9” through use of the redundancy group specified by part (C) of FIG. 21 as a unit of assignment. Then, the processing proceeds to Step S2707.

After that, as illustrated in FIG. 23 and FIG. 25, the control apparatus 101 reconstructs the state information based on the updated session group information 700 (Step S2707). Specifically, for example, the control apparatus 101 transmits, to each server 103-j, the entry corresponding to the each server 103-j among the entries of the session group information 700 to control the each server 103-j to reconstruct the state information. Further, as shown in FIG. 24, the control apparatus 101 updates, based on the updated session group information 700, the association information 122 held by each load distribution apparatus 102-j (Step S2708). With this, the redundancy group update processing ends.

As described above, at the time of the rearrangement of the state information after the removal of the server 103-j, even when a failure occurs in the removal group 104-g, the failure does not spread to affect another redundancy group. It is therefore possible to minimize the damage of the failure.

Further, for each of the redundancy groups 104-g, when its member server count falls below the minimum member server count α, the redundancy group 104-g is merged with another redundancy group, and hence it is possible to suppress an excessive increase in the number of redundancy groups, and to maintain an appropriate number of the redundancy groups 104-g. In other words, when the server count of a given redundancy group 104-g falls below the minimum member server count α, the number of sessions (state information items Sp-1 and Sp-2) assigned to the servers 103-j included in the given redundancy group 104-g relatively increases, and hence a processing load on each server increases. Accordingly, through the merging of a given redundancy group with another redundancy group when the server count of the given redundancy group falls below the minimum member server count α, the reduction in the processing load on each server 103-j can be achieved. Further, the member server count of the redundancy group 104-g after the merging becomes the predetermined value (e.g., 2α) or more, the redundancy group 104-g is divided. It is therefore possible to suppress the expansion of the affected range of the failure.

### Second Embodiment

Next, a description is given of a second embodiment of this invention. In the configuration of the first embodiment, the state information item Sp-1 as the operational data is stored in the operational data set R1-j of the server 103-j, whereas the state information item Sp-2 as the redundant data is stored in another server 103-k (j≠k). In contrast, in the second embodiment, the state information item Sp-2 as the redundant data of the state information item Sp-1 stored in the operational data set R1-j of the server 103-j is stored in all servers 103-k (j≠k) belonging to the same redundancy group 104-g as that of the server 103-j. Accordingly, in the case of the second embodiment, in the session group information 700, as the session group numbers of the redundant data, all session group numbers other than the session group number of the operational data of the corresponding entry are stored. For example, in the case of the session group information 700 shown in FIG. 7, in the entry having the server number “1”, “2” and “6” are stored in addition to “1” and “5” as the session group numbers of the redundant data. It should be noted that the same configurations as those of the first embodiment are denoted by the same reference symbols, and descriptions thereof are omitted.

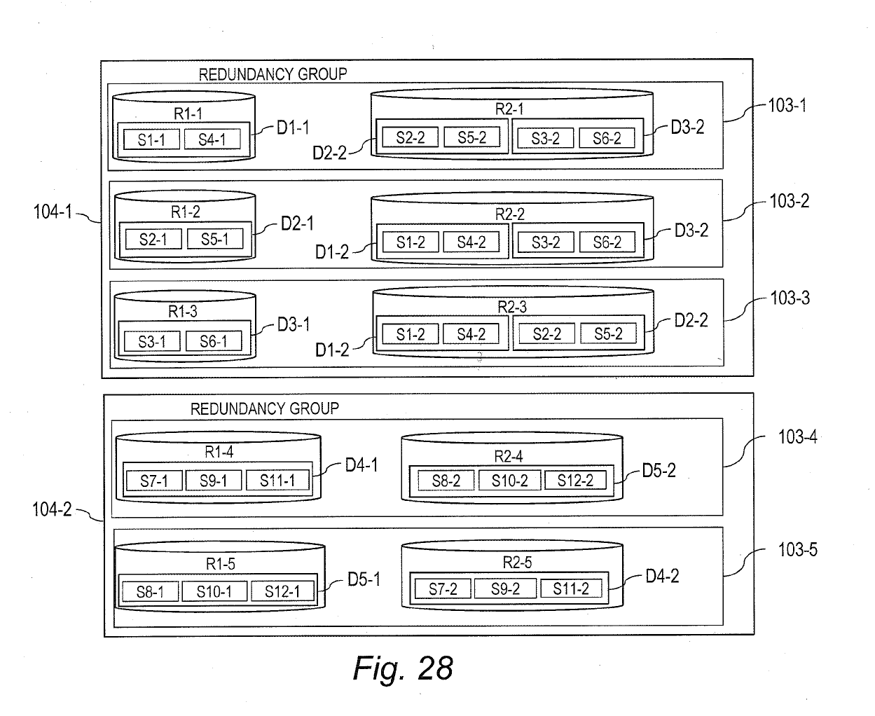

FIG. 28 is an explanatory diagram illustrating redundancy groups according to the second embodiment. The operational data set R1-j of the server 103-j stores an operational data group D1-j of all session groups (state information items Sp-1) to be processed by the server 103-j. Further, the redundant data set R2-j of the server 103-j stores a redundant data group Dk-2 of all session groups (Sp-2) to be processed by all the other servers 103-k (k≠j) belonging to the same redundancy group 104-g as that of the server 103-j.

For example, when three servers of the servers 103-1 to 103-3 belong to the redundancy group 104-1, the redundant data set R2-1 of the server 103-1 stores a redundant data group D2-2, which is the redundant data items (S2-2 and S5-2) of all the sessions (S2-1 and S5-1) to be processed by the server 103-2, and a redundant data group D3-2, which is the redundant data items (S3-2 and S6-2) of all the sessions (S3-1 and S6-1) to be processed by the server 103-3. Similarly, the redundant data set R2-2 of the server 103-2 and the redundant data set R3-2 of the server 103-3 each store the redundant data group Dk-2 of all the session groups (Sp-2) to be processed by all the other servers 103-k.

When the server 103-(N+1) is newly added, the operational data group Dj-1 of all the session groups to be processed by all the servers 103-j belonging to the redundancy group 104-g to which the server 103-(N+1) is added is replicated to be stored in a redundant data set R2-(N+1) of the server 103-(N+1) as a redundant data group Dj-2 of all the session groups to be processed by the servers 103-j.

Then, an operational data group D(N+1)-1 of all the session groups to be processed by the server 103-(N+1) is replicated to be stored in the redundant data sets R2-j of all the servers 103-j belonging to the redundancy group 104-g. In this manner, redundant system reconstruction processing is executed.

Further, when an arbitrary one of the servers 103-j is removed, one of the servers 103-k (k≠j) belonging to the same redundancy group 104-g as that of the removed server 103-j takes over the processing of the removed server 103-j. In this manner, failure recovery processing is executed. Further, the server 103-k to take over the processing of the removed, server 103-j includes the session group that has been processed by the removed server 103-j in its operational data set R1-k. Then, the server 103-k to take over the processing of the removed server 103-j replicates the operational data included in its operational data set R1-k to all the other servers 103-1 (l≠j, k) included in the redundancy group 104-g. in this manner, the redundant system reconstruction processing is executed.

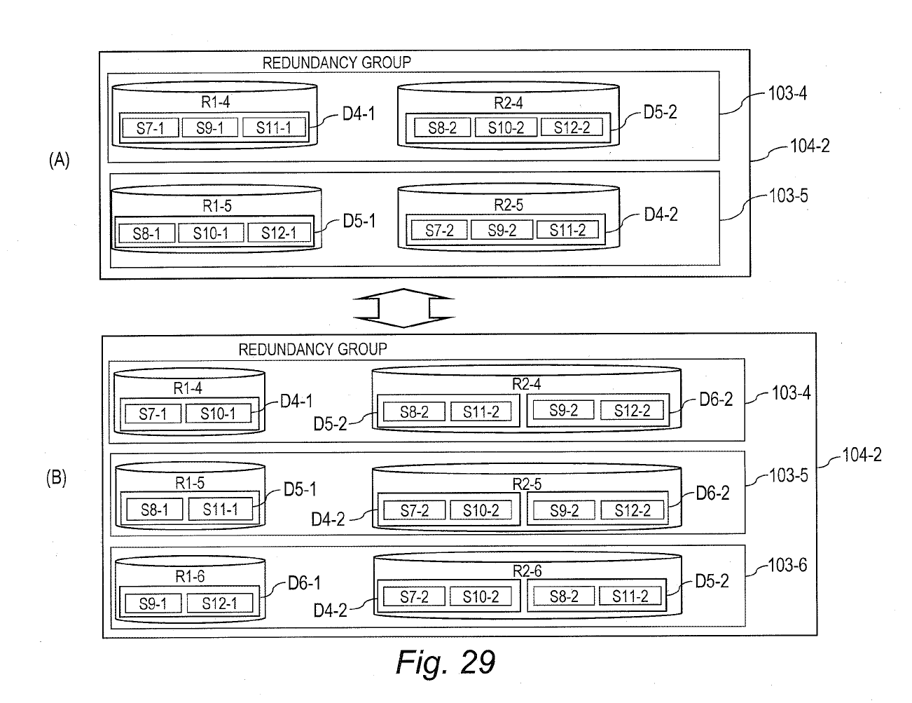

FIG. 29 is an explanatory diagram illustrating a state information rearrangement example caused by the addition or removal of the server according to the second embodiment. Transition from part (A) of FIG. 29 to part (B) of FIG. 29 is a rearrangement example performed when in the redundancy group 104-2, the server 103-6 is added under the state of part (A) of FIG. 29. Transition from part (B) of FIG 29 to part (A) of FIG. 29 is a rearrangement example performed when in the redundancy group 104-2, the server 103-6 is removed under the state of part (B) of FIG. 29.

As described above, according to the second embodiment, each server 103-j stores the redundant data of all the other servers 103-k (k≠j) of the redundancy group 104-g to which the each server 103-j belongs, and hence even, when a plurality of servers 103-j fail at the same time, the failure recovery processing can be executed. Further, by limiting the range in which the data is replicated to the servers 103-j included in the redundancy group 104-g, it is possible to suppress time required to replicate data to the plurality of servers 103-j and a storage capacity that each of the servers 103-j is required to have. It is therefore possible to achieve the enhancement of a fault tolerance of the management system at low cost.

### Third Embodiment

Next, a description is given of a third embodiment of this invention. The third embodiment is an embodiment in which in the first and second embodiments, a storage apparatus provided outside the servers 103-j stores the redundant data set of each of the servers 103-j. With this, it is possible to reduce a consumed capacity of a storage area of each of the servers 103-j.

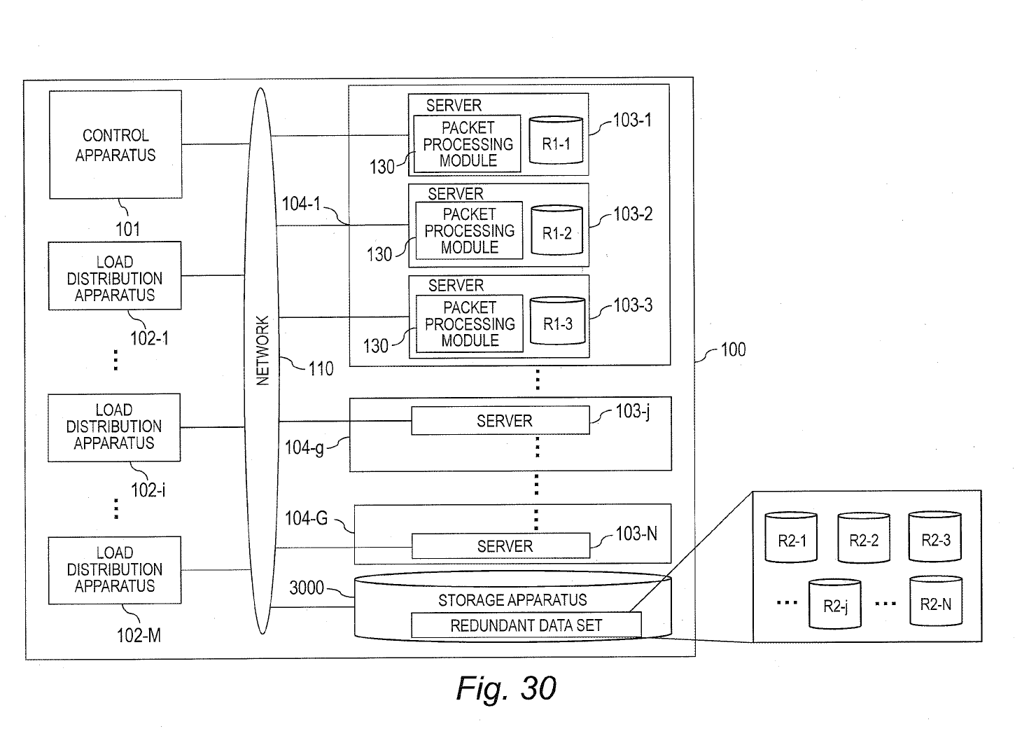

FIG. 30 is a block diagram illustrating a hardware configuration example of a management system 100 according to the third embodiment. The management system 100 includes a storage apparatus 3000 configured to store redundant data sets R2-1 to R2-N of the respective servers 103-j. The storage apparatus 3000 is coupled to the network 110.

In the third embodiment, all the redundant data sets R2-j are stored in the storage apparatus 3000. Accordingly, instead of the change of settings between operation and redundancy described above in the first embodiment, through the migration of data from the storage apparatus 3000 to the server 103-j, the state information item Sp-2 of the redundant data set R2-j is stored as the state information item Sp-1 of the operational data set R1-j.

As described above, in the third embodiment, the redundant data sets R2-j are stored in the storage apparatus 3000 provided outside the servers 103-j, it is possible to reduce the consumed capacity of the storage area of each of the servers 103-j. Further, by limiting, at the time of the state information rearrangement after the addition or removal of the server 103-j, the server to access the storage apparatus 3000 to the servers 103-j included in one of the redundancy groups 104-g, it is possible to suppress the number of servers simultaneously accessing the storage apparatus 3000. Accordingly, at the time of the state information rearrangement after the addition or removal of the server 103-j, a read speed of each server 103-j is enhanced, and hence a processing load on the storage apparatus 3000 can be reduced.

From the above description, according to this embodiment, in the load distribution and the redundant system reconstruction, the affected range of a failure that may occur during the rearrangement of the state information can be suppressed. Further, in the above descriptions of the first to third embodiments, the management system in which the control apparatus, the load distribution apparatus, and the servers are coupled to one another via the network is exemplified, but those computers may operate as one computer. In this case the network is replaced with a switch.

Further, in the above descriptions of the embodiments, the state information items Sp-1 and Sp-2 of the session groups are exemplified, but without being limited to the session, another type of information may be used as long as the operational data and the redundant data for backup thereof are stored.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment, Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A control apparatus configured to control a plurality of data processing apparatus capable of processing a group of operational data items, the group of operational data items being a group of data items currently used for operation,
the control apparatus comprising:
a processor configured to execute a program; and
a memory configured to store the program,
the processor being configured to execute:
calculation processing of calculating, based on a number of the plurality of data processing apparatus and a minimum count, which is a minimum number of data processing apparatus required to be included in one group, a number of groups to which the plurality of data processing apparatus are to belong;
first determination processing of determining, from among at least one group, which is specified based on the number of groups calculated by the calculation processing, an associated group of each of the plurality of data processing apparatus, the associated group being a group to which the each of the plurality of data processing apparatus is to belong;
second determination processing of determining, from among the group of operational data items, the operational data item to be assigned to the associated group determined by the first determination processing;
third determination processing of determining, as an assignment destination of the operational data item assigned to the associated group by the second determination processing, any one of the data processing apparatus belonging to the associated group whose number is the minimum count or larger, and of determining, as an assignment destination of a redundant data item that is a replica of the operational data item assigned to the associated group, from among the data processing apparatus belonging to the associated group whose number is the minimum count or larger, the data processing apparatus that is different from the data processing apparatus corresponding to an assignment destination of the operational data item that is an original of the redundant data item; and
assignment processing of assigning, based on determination results obtained by the second determination processing and the third determination processing, the group of operational data items and a group of the redundant data items to the plurality of data processing apparatus.

2. The control apparatus according to claim 1, wherein in the first determination processing, the processor determines, from among the at least one group, which is specified based on the number of groups calculated by the calculation processing, the associated group of the each of the plurality of data processing apparatus so that a difference in number of data processing apparatus among the at least one group is minimized.

3. The control apparatus according to claim 1, wherein in the second determination processing, the processor determines, from among the group of operational data items, the operational data item to be assigned to the associated group so that a difference in number of assigned operational data items among the at least one group is minimized.

4. The control apparatus according to claim 1, wherein in the third determination processing, the processor determines, as the assignment destination of the operational data item assigned to the associated group, any one of the data processing apparatus belonging to the associated group whose number is the minimum count or larger, so that a difference in number of assigned operational data items among the data processing apparatus included in the associated group is minimized.

5. The control apparatus according to claim 1, wherein in the third determination processing, the processor determines, as the assignment destination of the redundant data item that is the replica of the operational data item assigned to the associated group, from among the data processing apparatus belonging to the associated group whose number is the minimum count or larger, the data processing apparatus that is different from the data processing apparatus corresponding to the assignment destination of the operational data item that is the original of the redundant data item, so that a difference in number of assigned redundant data items among the data processing apparatus included in the associated group is minimized.

6. The control apparatus according to claim 1, wherein in the third determination processing, the processor determines, as the assignment destination of the operational data item assigned to the associated group, any one of the data processing apparatus belonging to the associated group whose number is the minimum count or larger, so that a larger number of operational data items are assigned to a first data processing apparatus having first processing performance than to a second data processing apparatus having second processing performance lower than the first processing performance, the first data processing apparatus and the second data processing apparatus being included in the data processing apparatus belonging to the associated group whose number is the minimum count or larger.

7. The control apparatus according to claim 1,
wherein in the first determination processing, the processor determines, when the data processing apparatus is added, from among the at least one group, the associated group of the added data processing apparatus based on a number of data processing apparatus belonging to each of the at least one group,
wherein in the third determination processing, the processor determines, as the assignment destination of the operational data item assigned to the associated group of the added data processing apparatus, any one of the data processing apparatus belonging to the associated group of the added data processing apparatus whose number is the minimum count or larger, and determines, as the assignment destination of the redundant data item that is the replica of the operational data item assigned to the associated group of the added data processing apparatus, from among the data processing apparatus belonging to the associated group of the added data processing apparatus whose number is the minimum count or larger, the data processing apparatus that is different from the data processing apparatus corresponding to the assignment destination of the operational data item that is the original of the redundant data item, and
wherein in the assignment processing, the processor assigns, based on determination results obtained by the second determination processing and the third determination processing, the group of operational data items and the group of the redundant data items to the plurality of data processing apparatus including the added data processing apparatus.

8. The control apparatus according to claim 1,
wherein when, through addition of the data processing apparatus, a number of data processing apparatus belonging to the associated group of the added data processing apparatus exceeds a maximum count, which is equal to or larger than the minimum count, the processor executes division processing of dividing the associated group of the added data processing apparatus into a first group and a second group,
wherein in the first determination processing, the processor determines, from between the first group and the second group obtained by the division processing, the associated group of the data processing apparatus that has belonged to the associated group of the added data processing apparatus,
wherein in the second determination processing, the processor determines, from among the operational data items that have been assigned to the associated group of the added data processing apparatus, the operational data item to be assigned to each of the first group and the second group, and
wherein in the third determination processing, the processor determines any one of the data processing apparatus belonging to the first group as the assignment destination of the operational data item determined to be assigned to the first group by the second determination processing, and determines any one of the data processing apparatus belonging to the second group as the assignment destination of the operational data item determined to be assigned to the second group by the second determination processing, and the processor determines, as the assignment destination of the redundant data item that is the replica of the operational data item assigned to the first group, from among the data processing apparatus belonging to the first group, the data processing apparatus that is different from the data processing apparatus corresponding to the assignment destination of the operational data item that is the original of the redundant data item, and determines, as the assignment destination of the redundant data item that is the replica of the operational data item, assigned to the second group, from among the data processing apparatus belonging to the second group, the data processing apparatus that is different from the data processing apparatus corresponding to the assignment destination of the operational data item that is the original of the redundant data item.

9. The control apparatus according to claim 1, wherein in the third determination processing, when the data processing apparatus belonging to any one of the at least ore group is removed the processor determines, as the assignment destination of the operational data item that has been assigned to the any one of the at least one group, any one of remaining data processing apparatus belonging to the any one of the at least one group, and determines, as the assignment destination of the redundant data item, that is the replica of the operational data item that has been assigned to the any one of the at least one group, from among the remaining data processing apparatus, the data processing apparatus that is different from the data processing apparatus corresponding to the assignment destination of the operational data item that is the original of the redundant data item.

10. The control apparatus according to claim 1,
wherein when, through removal of the data processing apparatus belonging to any one of the at least one group, a number of data processing apparatus belonging to the any one of the at least one group becomes smaller than the minimum count, the processor executes merging processing of merging any one of the at least one group with another group, and
wherein in the third determination processing, the processor determines, as the assignment destination of each of the operational data items that have been assigned to the any one of the at least one group and the another group, any one of the data processing apparatus belonging to a group obtained by the merging processing, and determines, as the assignment destination of the redundant data item that is the replica of each of the operational data items that have been assigned to the any one of the at least one group and the another group, from among the data processing apparatus belonging to the group obtained by the merging, the data processing apparatus that is different from the data processing apparatus corresponding to the assignment destination of the operational data item that is the original of the redundant data item.

11. The control apparatus according to claim 10,
wherein when a number of data processing apparatus belonging to the group obtained by the merging exceeds a maximum count, which is equal to or larger than the minimum count, the processor performs division processing of dividing the group obtained by the merging into a first group and a second group,
wherein in the first determination processing, the processor determines, from between the first group and the second group obtained by the division processing, the associated group of the data processing apparatus belonging to the group obtained by the merging so that a difference in number of data processing apparatus between the first group and the second group is minimized,
wherein in the second determination processing, the processor determines, from among the operational data items that have been assigned to the group obtained by the merging, the operational data item to be assigned to each of the first group and the second group, and
wherein in the third determination processing, the processor determines any one of the data processing apparatus belonging to the first group as the assignment destination of the operational data item determined to be assigned to the first group by the second determination processing, and determines any one of the data processing apparatus belonging to the second group as the assignment destination of the operational data item determined to be assigned to the second group by the second determination processing, and the processor determines, as the assignment destination of the redundant data item that is the replica of the operational data item assigned to the first group, from among the data processing apparatus belonging to the first group, the data processing apparatus that is different from the data processing apparatus corresponding to the assignment destination of the operational data item that is the original of the redundant data item, and determines, as the assignment destination of the redundant data item that is the replica of the operational data item assigned to the second group, from among the data processing apparatus belonging to the second group, the data processing apparatus that is different from the data processing apparatus corresponding to the assignment destination of the operational data item that is the original of the redundant data item.

12. The control apparatus according to claim 1, wherein the control apparatus is capable of accessing a storage apparatus configured to store, outside the plurality of data processing apparatus the group of the redundant data items.

13. A management system, comprising
a plurality of data processing apparatus capable of processing a group of operational data items, the group of operational data items being a group of data items currently used for operation; and
a control apparatus configured to control the plurality of data processing apparatus,
the control apparatus comprising:
a processor configured to execute a program; and
a memory configured to store the program,
the processor being configured to execute:
calculation processing of calculating, based on a number of the plurality of data processing apparatus and a minimum count, which is a minimum number of data processing apparatus required to be included in one group, a number of groups to which the plurality of data processing apparatus are to belong;
first determination processing of determining, from among at least one group, which is specified based on the number of groups calculated by the calculation processing, an associated group of each of the plurality of data processing apparatus, the associated group being a group to which the each of the plurality of data processing apparatus is to belong;
second determination processing of determining, from among the group of operational data items, the operational data item to be assigned to the associated group determined by the first determination processing;
third determination processing of determining, as an assignment destination of the operational data item assigned to the associated group by the second determination processing, any one of the data processing apparatus belonging to the associated group whose number is the minimum count or larger, and of determining, as an assignment destination of a redundant data item that is a replica of the operational data item signed to the associated group, from among the data processing apparatus belonging to the associated group whose number is the minimum count or larger, the data processing apparatus that is different from the data processing apparatus corresponding to an assignment destination of the operational data item that is an original of the redundant data item; and
assignment processing of assigning, based on determination results obtained by the second determination processing and the third determination processing, the group of operational data items and a group of the redundant data items to the plurality of data processing apparatus.

14. A control method performed by a control apparatus configured to control a plurality of data processing apparatus capable of processing a group of operational data items, the group of operational data items being a group of data items currently used for operation,
the control apparatus comprising:
a processor configured to execute a program; and
a memory configured to store the program,
the control method comprising executing, by the processor:
calculation processing of calculating, based on a number of the plurality of data processing apparatus and a minimum count, which is a minimum number of data processing apparatus required to be included in one group, a number of groups to which the plurality of data processing apparatus are to belong;
first determination processing of determining, from among at least one group, which is specified based on the number of groups calculated by the calculation processing, an associated group of each of the plurality of data processing apparatus, the associated group being a group to which the each of the plurality of data processing apparatus is to belong;
second determination processing of determining, from among the group of operational data items, the operational data item to be assigned to the associated group determined by the first determination processing;
third determination processing of determining, as an assignment destination of the operational data item assigned to the associated group by the second determination processing, any one of the data processing apparatus belonging to the associated group whose number is the minimum count or larger, and of determining, as an assignment destination of a redundant data item that is a replica of the operational data item assigned to the associated group, from among the data processing apparatus belonging to the associated group whose number is the minimum count or larger, the data processing apparatus that is different from the data processing apparatus corresponding to an assignment destination of the operational data item that is an original of the redundant data item; and
assignment processing of assigning, based on determination results obtained by the second determination processing and the third determination processing, the group of operational data items and a group of the redundant data items to the plurality of data processing apparatus.
